(19) United States
(12) Patent Application Publication
(10) Pub. No.: US 2015/0160131 A1
(43) Pub. Date: Jun. 11, 2015

(54) PARTICLE DETECTING DEVICE AND PARTICLE DETECTING METHOD

(71) Applicant: AZBIL CORPORATION, Tokyo (JP)

(72) Inventor: Seiichiro KINUGASA, Tokyo (JP)

(73) Assignee: AZBIL CORPORATION, Tokyo (JP)

(21) Appl. No.: 14/558,984

(22) Filed: Dec. 3, 2014

(30) Foreign Application Priority Data
Dec. 6, 2013 (JP) 2013-253661

(51) Int. Cl. G01N 21/64; G01N 15/10

(52) U.S. Cl. CPC G01N 21/64; G01N 15/1012; G01N 2201/062; G01N 2201/06113; G01N 2201/127

(57) ABSTRACT

A particle detecting device includes: a light source that illuminates a fluid with an excitation beam; a fluorescent intensity measuring instrument that measures an optical intensity of a fluorescent band, generated in a region that is illuminated by the excitation beam, at two or more wavelengths; an evaluating portion that compares a measured value for the optical intensity and a boundary range, which is a range of optical intensities at two or more wavelengths for discriminating between a fluorescent particle that is a subject to be detected and a particle that is not a subject to be detected, and evaluates whether or not a fluid includes a fluorescent particle that is a subject to be detected; and a correcting portion that corrects the boundary range in accordance with the status of at least one of the light source and the fluorescent intensity measuring instrument.

### CROSS REFERENCE TO RELATED APPLICATION

This application claims priority under 35 U.S.C. §119 to Japanese Patent Application No. 2013-253661, filed on Dec. 6, 2013, the entire content of which being hereby incorporated herein by reference.

### FIELD OF TECHNOLOGY

The present disclosure relates to an environment evaluating technology, and, in particular, relates to a particle detecting device and particle detecting method.

### BACKGROUND ART

In clean rooms, such as bio clean rooms, airborne microorganism particles and non-microorganism particles are detected and recorded using particle detecting devices. See, for example, Japanese Unexamined Patent Application Publication No. 2011-83214, Published Japanese Translation of a PCT Application filed in English 2008-530583, and N. Hasegawa, et al., Instantaneous Bioaerosol Detection Technology and Its Application, azbil Technical Review, 2-7, Yamatake Corporation, December 2009. The state of wear of the air-conditioning equipment of the clean room can be ascertained from the result of the particle detection. Moreover, a record of particle detection within the clean room may be added as reference documentation to the products manufactured within the clean room. Optical particle detecting devices draw in air from a clean room, for example, and illuminate the drawn-in air with light. When there is a microorganism particle or non-microorganism fluorescent particle included within the air, a particle that is illuminated with light emits fluorescence, so detecting, using a photodetecting element, the fluorescence emitted from the particle enables detection of the numbers, sizes, and the like, of microorganism particles or non-microorganism fluorescent particles included in the air. Moreover, there is the need for technologies for accurately detecting particles in a fluid outside of clean rooms as well. See, for example, Japanese Unexamined Patent Application Publication H8-29331.

For example, if the particle detecting device includes a photoelectron multiplier tube as the photodetecting element, then when the cumulative illuminated luminous flux into the photomultiplier tube is increased through the structure and the coating status of the anode, there will be a change in the sensitivity of the photoelectron multiplier tube. When the cumulative illuminated luminous flux is increased, then the sensitivity of the photoelectron multiplier tube may increase temporarily, for example, but as time passes, there will be a tendency for it to decrease. Moreover, the sensitivity of the photoelectron multiplier tube will decrease depending on the temperature at the time of storage and on the temperature at the time of use as well. When, in response, an attempt is made to increase the fluorescent intensity by increasing the strength of the excitation beam that illuminates the fluorescent particles after there has been a breakdown in the sensitivity of the photoelectron multiplier tube, then the number of photons that enter into the photoelectron multiplier tube will be increased, increasing the load on the cathode electrode, which may promote further breakdown of the photoelectron multiplier tube. Moreover, the breakdown of the photodetecting element in the particle detecting device is not limited to just the photoelectron multiplier tube. When the optical intensity measuring instrument of the particle detecting device breaks down, the particle detecting device may no longer be able to measure the fluorescent particles accurately. Given this, an aspect of the present invention is to provide a particle detecting device and particle detecting method able to detect accurately the fluorescent particles that are the subjects of detection.

### SUMMARY

An example of the present disclosure provides:

(a) a light source that illuminates a fluid with an excitation beam;

(b) a fluorescent intensity measuring instrument that measures the optical intensity of the fluorescent band, generated in a region that is illuminated by an excitation beam, at two or more wavelengths;

(c) a boundary range storing device that stores, as a boundary range, a range of optical intensities at two or more wavelengths for discriminating between a fluorescent particle that is a subject to be detected and a particle that is not a subject to be detected;

(d) an evaluating portion that compares a measured value for the optical intensity and a boundary range to evaluate whether or not a fluid includes a fluorescent particle that is a subject to be detected, and evaluates that, when the measured value for the optical intensity is included in the boundary range, an evaluation whether or not the fluid includes a fluorescent particle that is a subject to be detected is not possible; and

(e) a correcting portion that corrects the boundary range in accordance with the status of at least one of the light source and the fluorescent intensity measuring instrument,

(f) the above (a)-(e) being provided in the structure of a particle detecting device. Note that “fluorescent light” includes autofluorescent light. Note that a “fluid” includes “gases” and “liquids.”

Moreover, another example of the present disclosure provides:

(a) illuminating a fluid with an excitation beam;

(b) measuring, at two different wavelengths, the optical intensity of fluorescent bands that are produced in a region that is illuminated by the excitation beam;

(c) preparing, as a boundary range, a range of optical intensities at the two or more wavelengths in order to discriminate between a fluorescent particle that is a subject to be detected and a particle that is not a subject to be detected;

(d) comparing a measured value for the optical intensity and a boundary range to evaluate whether or not a fluid includes a fluorescent particle that is a subject to be detected, and evaluating that, when the measured value for the optical intensity is included in the boundary range, an evaluation whether or not the fluid includes a fluorescent particle that is a subject to be detected is not possible; and

(e) correcting the boundary range in accordance with the status of at least one of the light source and the fluorescent intensity measuring instrument,

(f) the above (a)-(e) being provided in a particle detecting method.

The present disclosure enables the provision of a particle detecting device and particle detecting method wherein fluorescent particles, which are the particles that are subject to detection, can be detected accurately.

### BRIEF DESCRIPTIONS OF THE DRAWINGS

FIG. 1 is a schematic diagram of a clean room according to Example according to the present disclosure.

FIG. 2 is a graph illustrating a relationship between the intensity in the 440-nm band relative to the intensity in the band that is greater than 530 nm, of the light that is produced by a microorganism and by a substance that is included in the atmosphere in the Example according to the present invention.

FIG. 3 is a schematic diagram of a particle detecting device according to the Example according to the present disclosure.

FIG. 4 is a flowchart illustrating an optical intensity measuring method as set forth in the Example according to the present disclosure.

FIG. 5 is a graph illustrating the change over time in the optical intensity in the fluorescent band in the Example according to the present disclosure.

FIG. 6 is a flowchart illustrating a method for obtaining a reference value as set forth in the Example according to the present disclosure.

FIG. 7 is a graph illustrating a boundary range relating to the Example according to the present disclosure.

FIG. 8 is a graph illustrating the change over time in the sensitivity of a first photodetecting element in the Example according to the present disclosure.

FIG. 9 is a graph illustrating the change over time in the effect, of the drop in the sensitivity of a second photodetecting element, on the correlation of the optical intensity in the Example according to the present disclosure.

FIG. 10 is a graph illustrating the change over time in the effect, of the drop in the sensitivity of the first and second photodetecting elements, on the correlation of the optical intensity in the Example according to the present disclosure.

FIG. 11 is a graph illustrating the change over time in the breakdown coefficient of a first photodetecting element in the Example according to the present disclosure.

FIG. 12 is a graph illustrating a boundary range relating to the Example according to the present disclosure.

FIG. 13 is a graph illustrating a boundary range relating to the Example according to the present disclosure.

FIG. 14 is a graph illustrating a boundary range relating to the Example according to the present disclosure.

FIG. 15 is a flowchart illustrating a method for correcting a reference value as set forth in the Example according to the present disclosure.

FIG. 16 is a flowchart illustrating a method for correcting a reference value as set forth in a first modified example of the Example according to the present disclosure.

FIG. 17 is a flowchart illustrating a method for correcting a reference value as set forth in a second modified example of the Example according to the present disclosure.

FIG. 18 is a flowchart illustrating a method for correcting a reference value as set forth in a third modified example of the Example according to the present disclosure.

FIG. 19 is a flowchart illustrating a method for correcting a reference value as set forth in a fourth modified example of the Example according to the present disclosure.

FIG. 20 is a flowchart illustrating a method for correcting a reference value as set forth in a fifth modified example of the Example according to the present disclosure.

FIG. 21 is a flowchart illustrating a method for correcting a reference value as set forth in a sixth modified example of the Example according to the present disclosure.

FIG. 22 is a flowchart illustrating a method for correcting a reference value as set forth in a seventh modified example of the Example according to the present disclosure.

FIG. 23 is a flowchart illustrating a method for measuring the optical intensity as set forth in an eighth modified example of the Example according to the present disclosure.

FIG. 24 is a graph illustrating the change over time in the optical intensity in the fluorescent band in the eighth modified example of the Example according to the present disclosure.

FIG. 25 is a flowchart illustrating a method for measuring the optical intensity as set forth in a ninth modified example of the Example according to the present disclosure.

FIG. 26 is a graph illustrating the change over time in the optical intensity in the fluorescent band in the ninth modified example of the Example according to the present disclosure.

FIG. 27 is a flowchart illustrating a method for measuring the optical intensity as set forth in a 10th modified example of the Example according to the present disclosure.

FIG. 28 is a graph illustrating the change over time in the optical intensity in the fluorescent band in the 10th modified example of the Example according to the present disclosure.

### DETAILED DESCRIPTION

Examples of the present disclosure will be described below. In the descriptions of the drawings below, identical or similar components are indicated by identical or similar codes. Note that the diagrams are schematic. Consequently, specific measurements should be evaluated in light of the descriptions below. Furthermore, even within these drawings there may, of course, be portions having differing dimensional relationships and proportions.

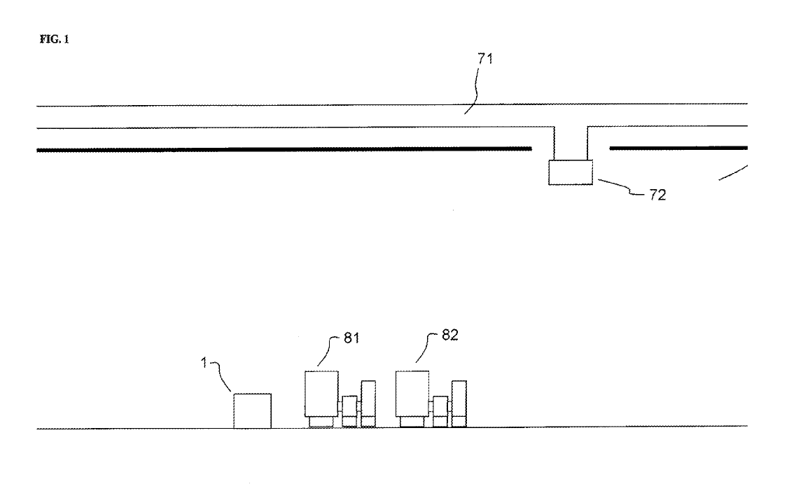

As illustrated in FIG. 1, a particle detecting device 1 according to the present example is disposed in, for example, a clean room 70. In the clean room 70, clean air is blown in through a duct 71 and through a blowing opening 72 having an ultrahigh performance air filter such as a HEPA filter (High Efficiency Particulate Air Filter) or ULPA filter (Ultra Low Penetration Air Filter), or the like.

Manufacturing lines 81 and 82 are arranged inside of the clean room 70. The manufacturing lines 81 and 82 are manufacturing lines, for, for example, precision instruments, electronic components, or semiconductor devices. Conversely, the manufacturing lines 81 and 82 may be manufacturing lines for foodstuffs, beverages, or pharmaceuticals. For example, in the manufacturing lines 81 and 82, an infusion liquid may be filled into an intravenous infusion device or a hypodermic. Conversely, the manufacturing lines 81 and 82 may manufacture oral medications or Chinese herb medications. On the other hand, the manufacturing lines 81 and 82 may fill containers with a vitamin drink or beer.

The manufacturing lines 81 and 82 normally are controlled so that microorganism particles and non-microorganism particles, and the like, are not dispersed into the air within the clean room 70. However, manufacturing lines 81 and 82, for some reason, are sources that produce microorganism particles and non-microorganism particles that become airborne in the clean room 70. Moreover, factors other than the manufacturing lines 81 and 82 also disperse microorganism particles and non-microorganism particles into the air of the clean room 70.

Examples of microorganism particles that may become airborne in the clean room 70 include microbes. Examples of such microbes include Gram-negative bacteria, Gram-positive bacteria, and fungi such as mold spores. Escherichia coli, for example, can be listed as an example of a Gram-negative bacterium. Staphylococcus epidermidis, Bacillus atrophaeus, Micrococcus lylae, and Corynebacterium afermentans can be listed as examples of Gram-positive bacteria. Aspergillus niger can be listed as an example of a fungus such as a mold spore. However, the microorganism particles that may become airborne in the clean room 70 are not limited to these specific examples. Examples of non-microorganism particles that may become airborne in the clean room 70 include splashed chemical substances, pharmaceuticals, or foodstuffs, along with dust, dirt, grime, and the like.

If a microorganism particle is illuminated with light, the nicotinamide adenine dinucleotide (NADH) and the flavins, and the like, that are included in microorganism particle produce fluorescent light. However, fluorescent particles that fall off of a gown, made from polyester, for example, that has been cleaned will emit fluorescence when illuminated with light. Moreover, polystyrene particles also emit fluorescence, and then fade. Consequently, conventionally, particle detecting devices have identified the existence of fluorescent particles that are subjects to be detected within the air by illuminating the air with an excitation beam and detecting the fluorescence. Note that “fluorescent light” includes autofluorescent light.

Here the present inventor discovered that even if there are no fluorescent particles that produce fluorescence, as described above, in the air, when a decontaminating gas, or the like, for a decontaminating contamination such as nitrogen oxides (NOX), including nitrogen dioxide (NO2), sulfur oxides (SOX), ozone gas (O3), aluminum oxide gases, aluminum alloys, glass powder, and Escherichia coli, mold, and the like, is included in the air, substances included in the air that are smaller than the particles that produce Mie scattering will absorb the excitation beam and emit light in the fluorescent band, causing conventional particle detecting devices to produce a “false detection” as if there were fluorescent particles that were subjects to be detected. Note that “light of the fluorescent band” is not limited to fluorescence, but rather this wavelength band includes also scattered light that overlaps with the fluorescence.

For example, when nitrogen dioxide absorbs gas, light that has shifted in the red direction is emitted, to return to the ground state. The absorption spectrum of nitrogen dioxide has a peak in the vicinity of 440 nm, and has a wide band of between 100 and 200 nm. Because of this, when, in the presence of nitrogen dioxide, an NADH-derived or flavin-derived fluorescence, which has a wavelength of 405 nm, is stimulated, then fluorescence will be stimulated in the nitrogen dioxide as well, which overlaps the absorption spectrum of the excitation beam for the NADH and the flavin. Moreover, nitrogen dioxide is produced by a reaction between nitrogen and oxygen in the air when a material is combusted. Because of this, even if there is no nitrogen dioxide included in the air that was originally to be tested, when the particle detecting device illuminates the air with a laser beam with a high beam density, or a strong electromagnetic emission line, as the excitation beam, substances within the air may combust to produce nitrogen dioxide, where this nitrogen dioxide will emit fluorescence. Moreover, carbon monoxide and ozone may react to produce nitrogen dioxide, which also emits fluorescence.

In regards to nitrogen dioxide, see Japanese Unexamined Patent Application Publication 2003-139707, Joel A. Thornton, et al., “Atmospheric NO2:In Situ Laser-Induced Fluorescence Detection at Parts-per-Trillion Mixing Ratios,” Analytical Chemistry, Vol. 72, No. 3, Feb. 1, 2000, Pages 528-539, and S. A. Nizkorodov, et al., “Time-Resolved Fluorescence of NO2 in a Magnetic Field,” Vol. 215, No. 6, Chemical Physics Letters, 17 Dec. 1993, Pages 662-667. For sulfur dioxide, see Japanese Unexamined Patent Application Publication 2012-86105.

Typically, the intensity of fluorescence derived from the substances included in the air, such as nitrogen dioxide, is weaker than the intensity of fluorescence derived from microorganism particles. However, the lifetime of the fluorescence derived from nitrogen dioxide, although dependent on the ambient pressure, is in the order of microseconds, which is longer than the lifetime of the fluorescence derived from microorganism particles, such as Escherichia coli and Bacillus subtilis, and the like, which is in the order of nanoseconds. The response frequency of the photodetecting element, such as a photoelectron multiplier tube or a photodiode that operates in the Geiger mode, or the like, and of the detecting circuit that is provided with an integrator, or the like, in the particle detecting device is about 1 MHz, where the time constant is in the order of microseconds. Because of this, the current that is outputted by the detector circuit that calculates the number of photons will be greater when detecting the fluorescence derived from nitrogen dioxide, which, although weak, has a long lifetime, than when detecting fluorescence derived from microorganism particles which, although strong, has a short lifetime.

Moreover, the fluorescent spectrum derived from nitrogen dioxide has a wide bandwidth, overlapping the fluorescent spectrum derived from flavin. Because of this, when, for example, evaluating whether or not microorganism particles are present by detecting only whether or not there is light from the fluorescent band that derives from flavin, there may be cases wherein there are false evaluations that microorganism particles exist, despite the fact that it is fluorescence derived from nitrogen dioxide that is detected. It is possible that this problem cannot be solved even if the time constant of the

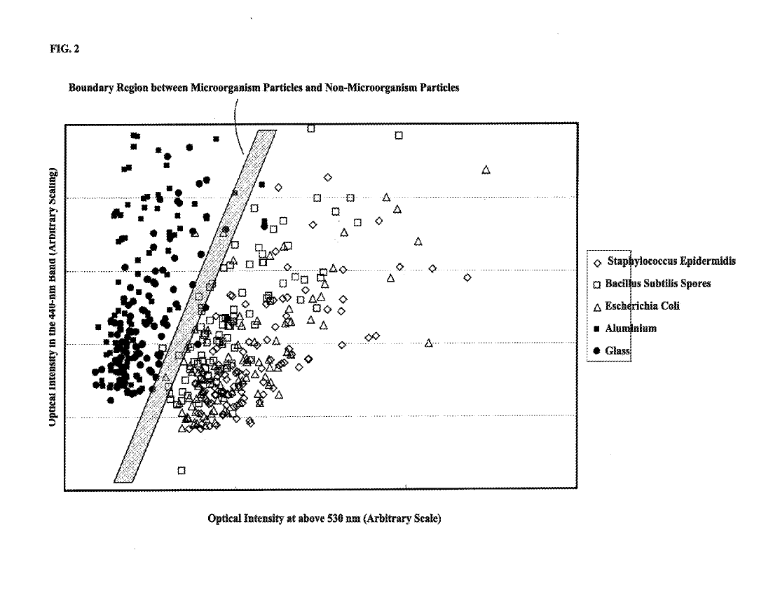

Here, at the conclusion of diligent research, the present inventor discovered that when the optical intensities of fluorescent bands produced by substances are measured at a plurality of wavelengths, the correlation between the optical intensity at a given wavelength and the optical intensity at another wavelength will vary from substance to substance. For example, FIG. 2 is a graph plotting the optical intensities at wavelengths in the band above 530 nm, on the horizontal axis, and the optical intensities at wavelengths of the band near 440 nm, on the vertical axis, for light in the fluorescent band emitted respectively from Staphylococcus epidermidis, Bacillus subtilis spores, Escherichia coli, glass, and aluminum, illuminated by an excitation beam. As illustrated in FIG. 2, the ratio of the optical intensities of the wavelengths in the band near 440 nm relative to the optical intensities of the wavelengths in the band above 530 nm tends to be high for non-organisms, and tends to be low for microorganism particles. The present inventor discovered that it is possible to identify whether or not a substance is a fluorescent particle that is a subject to be detected through measuring the light intensities in the fluorescent band that are emitted by substances at a plurality of wavelengths, and then taking the correlations thereof.

Moreover, in relation to the correlations between the light intensities of the fluorescent bands for each of the plurality of wavelengths, it was discovered that it is possible to distinguish particles by setting a boundary range for the particles that are subjects to be detected and the particles that are not subjects to be detected so that, for example, those particles that produce a correlation value that is outside of the boundary range on the low side are particles that are subjects to be detected, and those particles that produce a correlation value that is outside of the boundary range on the high side are particles that are not subjects to be detected. Note that, depending on the method by which this correlation is taken, instead the particles that produce correlation values that are outside of the boundary range on the low side may be distinguished as the particles that are not subjects to be detected, and the particles that produce correlation values outside of the boundary range on the high side may be distinguished as the particles that are subjects to be detected.

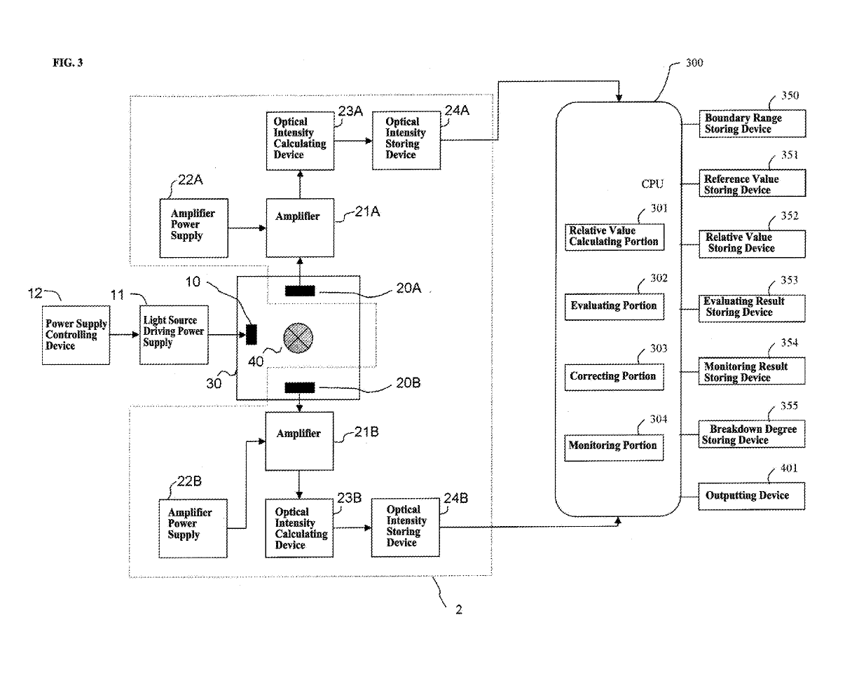

As illustrated in FIG. 3, the particle detecting device 1 according to the present example comprises: a light source 10 for directing an excitation beam into a fluid; and a fluorescent intensity measuring instrument 2 for measuring, at two or more wavelengths, the optical intensity in the fluorescent band emitted by the region that is illuminated with the excitation beam. The light source 10 and the fluorescent intensity measuring instrument 2 are connected electrically to a central calculating processing device (CPU) 300. The CPU 300 includes a relative value calculating portion 301 for calculating, as a measured relative value, a relative value between the light intensities measured at the two or more wavelengths.

A boundary range storing device 350 for storing, as a boundary range, a range of optical intensities at two or more wavelengths, for distinguishing between fluorescent particles that are subjects to be detected and particles that are not subjects to be detected, and a reference value storing device 351 for storing, as reference values, values based on the relative values for the light intensities that are emitted from prescribed substances that are illuminated with an excitation beam, measured at two or more wavelengths, are connected electrically to the CPU 300.

The CPU 300 further comprises: an evaluating portion 302 for comparing the measured relative values for the optical intensities, the reference values, and the boundary range, to evaluate whether or not the fluid contains fluorescent particles that are subjects to be detected, and for evaluating whether or not the fluid includes fluorescent particles that are subject to be detected cannot be determined, if the measured relative value of the optical intensities is within the boundary range; and a correcting portion 303 for correcting the boundary range depending on the status of the light source 10 and/or the fluorescent intensity measuring instrument 2.

Here the “relative values of light intensities measured at two or more wavelengths” refers to a ratio of an optical intensity at a first wavelength and an optical intensity at a second wavelength that is not the first wavelength, a ratio of the difference between the optical intensity at the first wavelength and the optical intensity at the second wavelength to the sum of the optical intensity at the first wavelength and the optical intensity at the second wavelength, or a difference between the optical intensity at the first wavelength and the optical intensity at the second wavelength.

The light source 10 and the fluorescent intensity measuring instrument 2 are provided in a frame 30. A light source driving power supply 11, for supplying electric power to the light source 10, is connected to the light source 10. A power supply controlling device 12, for controlling the electric power that is supplied to the light source 10, is connected to the light source driving power supply 11. The particle detecting device 1 further comprises a first suction device for drawing the air, into the frame 30 that is illustrated in FIG. 3, from within the clean room 70, illustrated in FIG. 1. The air that is drawn in by the first suction device is expelled from the tip end of a nozzle 40 of the flow path within the frame 30. The air that is emitted from the tip end of the nozzle 40 is drawn in by a second section device that is disposed within the frame 30, facing the tip end of the nozzle 40.

The light source 10 emits an excitation beam of a wide wavelength band towards the gas flow of the air that is expelled from the tip end of the nozzle 40 and drawn into the second suction device. A light-emitting diode (LED) or a laser may be used for the light source 10. The wavelength of the excitation beam is, for example, between 250 and 550 nm. The excitation beam may be of visible light, or of ultraviolet light. If the excitation beam is of visible light, then the wavelength of the excitation beam is within a range of, for example, 400 to 550 nm, for example, 405 nm. If the excitation beam is ultraviolet radiation, then the wavelength of the excitation beam is in a range of, for example, between 300 and 380 nm, for example, 340 nm. However, the wavelength of the excitation beam is not limited to these.

If a microorganism particle, such as a bacterium, or the like, is included in the gas flow that is expelled from the nozzle 40, the microorganism particle, illuminated by the excitation beam, emits fluorescence. Moreover, even in a case wherein a non-microorganism particle, such as a polyester particle, is included in the gas flow that is expelled from the nozzle 40, the non-microorganism particle that is illuminated by the excitation beam will emit fluorescence. Moreover, if nitrogen oxides (NO_{X}), including nitrogen dioxide (NO₂), sulfur oxides (SO_{X}), ozone gas (O₃), gases of aluminum oxides, aluminum alloys, glass powders, and decontaminating gases for decontaminating contamination such as Escherichia coli, molds, and the like, are included in the gas flow that is emitted from the nozzle 40, then these substances, illuminated by the excitation beam, will emit light in the fluorescent band.

The fluorescent strength measuring instrument 2 detects the light in the fluorescent band emitted by the microorganism particles that are subjects to be detected, and from the non-microorganism particles. The fluorescent strength measuring instrument 2 comprises: a first photodetecting element 20A for detecting light in the fluorescent band at a first wavelength, and a second photodetecting element 20B for detecting light of a fluorescent band at a second wavelength that is different from the first wavelength. Note that the “first wavelength” may have a band. The same is true for the second wavelength. A photodiode, a photoelectron tube, or the like may be used for the first photodetecting element 20A and the second photodetecting element 20B, to convert the photonic energy into electric energy when the light is detected.

An amplifier 21A for amplifying the current that is produced by the first photodetecting element 20A is connected to the first photodetecting element 20A. An amplifier power supply 22A, for supplying electric power to the amplifier 21A, is connected to the amplifier 21A. Moreover, an optical intensity calculating device 23A, for calculating the intensity of the light detected by the first photodetecting element 20A, by detecting the current that has been amplified by the amplifier 21A, is connected to the amplifier 21A. An optical intensity storing device 24A, for storing the optical intensity calculated by the optical intensity calculating device 23A, is connected to the optical intensity calculating device 23A.

An amplifier 21B for amplifying the current that is produced by the second photodetecting element 20B is connected to the second photodetecting element 20B. An amplifier power supply 22B, for supplying electric power to the amplifier 21B, is connected to the amplifier 21B. Moreover, an optical intensity calculating device 23B, for calculating the intensity of the light detected by the second photodetecting element 20B, by detecting the current that has been amplified by the amplifier 21B, is connected to the amplifier 21B. An optical intensity storing device 24B, for storing the optical intensity calculated by the optical intensity calculating device 23B, is connected to the optical intensity calculating device 23B.

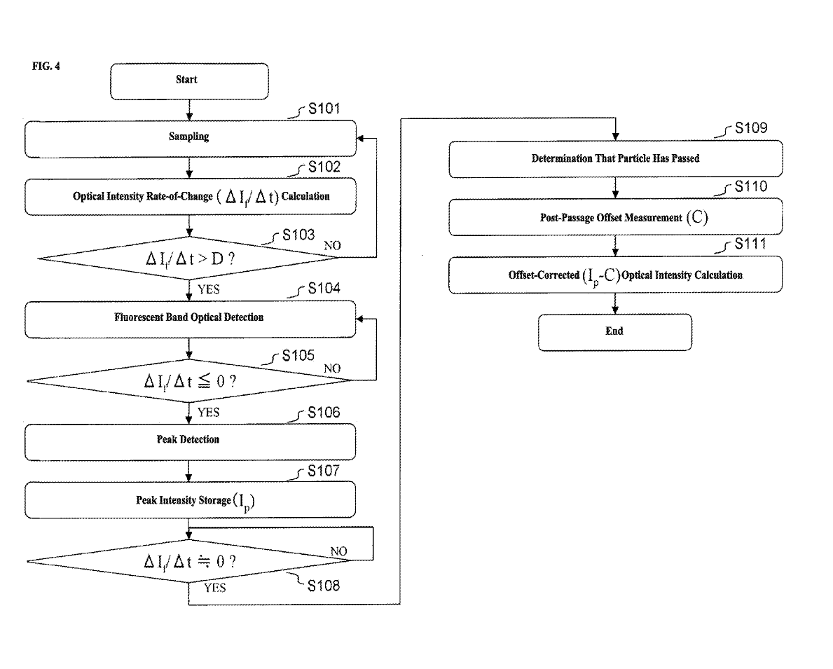

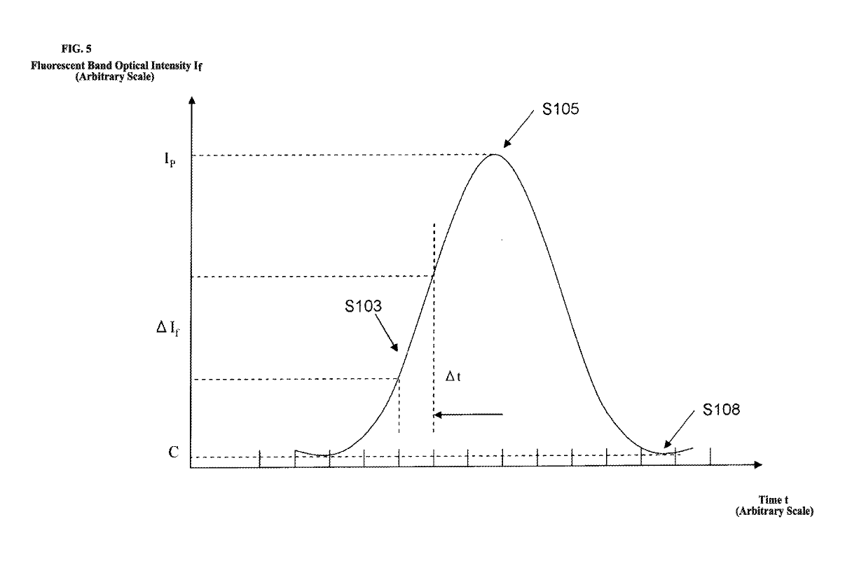

A flowchart wherein the fluorescent strength measuring instrument 2 calculates the intensity of light in the fluorescent band at the first wavelength, using the first photodetecting element 20A, is illustrated in FIG. 4. In Step S101, the particle detecting device 1, illustrated in FIG. 1, commences drawing in air from the outside of the frame 30, and the light source 10, illustrated in FIG. 3, shines an excitation beam into the gas flow of the air that is drawn in. In Step S102, the optical intensity calculating device 23A, included in the fluorescent intensity measuring instrument 2, calculates a rate of change over time in the intensity of light in the fluorescent band at the first wavelength detected by the first photodetecting element 20A. In Step S103, as illustrated in FIG. 5, if the rate of change over time ΔIf/Δt of the intensity of the light in the fluorescent band, detected by the first photodetecting element 20A, exceeds a prescribed threshold value D, then processing advances to Step S104, and the optical intensity calculating device 23A evaluates that there is actually detection of light in a fluorescent band derived from a particle or substance that is illuminated by the excitation beam. If the rate of change over time ΔI_{f}/Δt of the intensity of light in the fluorescent band is below the prescribed threshold value D, then processing returns to Step S101.

In Step S105, the optical intensity calculating device 23A evaluates whether or not the rate of change over time ΔIf/Δt of the intensity of light in the fluorescent band is 0 or less. If, as illustrated in FIG. 5, the rate of change over time ΔI_{f}/Δt of the intensity of light in the fluorescent band is 0 or less, then the optical intensity calculating device 23A detects the intensity I_{P} of the light in the fluorescent band at a peak, in Step S106. If the rate of change over time ΔI_{f}/Δt of the intensity of light in the fluorescent band is not 0 or less, then processing returns to Step S104.

In Step S107, the optical intensity calculating device 23A stores, into the optical intensity storing device 24A that is included in the fluorescent intensity measuring instrument 2, the intensity IP of the light of the fluorescent band at the peak. In Step S108, the fluorescent intensity measuring instrument 2, as illustrated in FIG. 5, evaluates whether or not the rate of change over time Δ_{f}/Δt of the intensity of light in the fluorescent band is near 0. If the rate of change over time Δ_{f}/Δt of the intensity of light in the fluorescent band is not near 0, then it stands-by until this rate of change approaches 0. When it approaches 0, then, in Step S109, the optical intensity calculating device 23A evaluates that the particle or substance has passed from the position illuminated by the excitation beam.

In Step S110, the optical intensity calculating device 23A, after evaluating that the particle or substance has passed, measures, as an offset C, the intensity of the light in the fluorescent band at the first wavelength, detected by the first photodetecting element 20A. In Step S111, the optical intensity calculating device 23A subtracts the offset C from the intensity IP of light in the fluorescent band at the peak that was saved in the optical intensity storing device 24A to calculate a corrected strength IPC of the light in the fluorescent band at the peak, and this is stored in the optical intensity storing device 24A as the intensity of light in the fluorescent band at the first wavelength.

The method by which the fluorescent strength measuring instrument 2, illustrated in FIG. 3, calculates the intensity of light in the fluorescent band at the second wavelength, using the second photodetecting element 20B, and saves it into the optical intensity storing device 24B is identical to the method set forth above, and thus the explanation thereof will be omitted.

The CPU 300 further includes a monitoring portion 304 for monitoring the fluorescent intensity measuring instrument 2. A monitoring portion 304 monitors the number of times that light of the fluorescent band at the first wavelength is detected by the first photodetecting element 20A, and the number of times that light of the fluorescent band at the second wavelength is detected by the second photodetecting element 20B.

The number of times that light of the fluorescent band at the first wavelength is detected by the first photodetecting element 20A refers to the cumulative number of times that the light of the fluorescent band at the first wavelength is detected by the first photodetecting element 20A, with the point in time at which the particle detecting device 1 is manufactured at the factory and installed in the clean room 70, for example, as the calculation starting point. Conversely, it may be the cumulative number of times that light in the fluorescent band at the first wavelength is detected by the first photodetecting element 20A, using, as the calculation starting point, a time at which the fluorescent intensity measuring instrument 2 is maintained. or, conversely, it may be the cumulative number of times that light in the fluorescent band at the first wavelength is detected by the first photodetecting element 20A using, as the calculation starting point, the point in time at which a boundary range, described below, is demarcated. The same is true for the number of times that light in the fluorescent band, at the second wavelength, is detected by the second photodetecting element 20B.

A monitoring result storing device 354 is connected to the CPU 300. The monitoring portion 304 saves, in the monitoring result storing device 354 the number of times that light in the fluorescent band at the first wavelength is detected by the first photodetecting element 20A and the number of times that light in the fluorescent band at the second wavelength is detected by the second photodetecting element 20B.

The reference value storing device 351 saves, as a reference value for a fluorescent particle that is a subject to be detected, a value based on the relative value of the intensity of light emitted from the fluorescent particle that is a subject to be detected when illuminated by the excitation beam, measured at two or more wavelengths, for example. Moreover, the reference value storing device 351 saves, as a reference value for a particle that is a subject to be detected, a value, a value based on the relative value of the intensity of light emitted from the particle that is not a subject to be detected, when illuminated by an excitation beam, measured at two or more wavelengths. In the present example, the explanation will be for an example wherein the fluorescent particle that is a subject to be detected is a microorganism particle, and the particle that is not a subject to be detected is a non-organism particle.

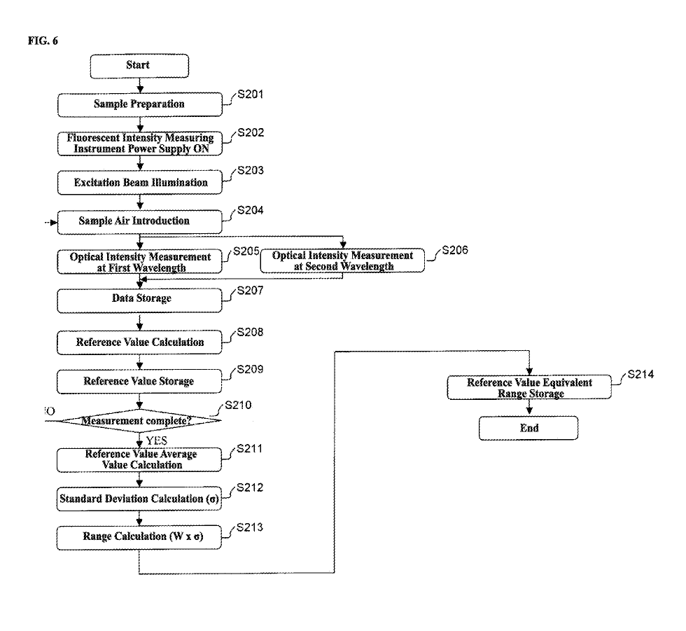

FIG. 6 is a flowchart illustrating a method for acquiring a reference value for a microorganism particle that is a subject to be detected, stored in the reference value storing device 351. In Step S201, a microorganism particle that is a subject to be detected is prepared. Here clean air, from which contaminants have been eliminated, is prepared, and the microorganism particle that is to be subject to detection is included therein. In Step S202, the power supply is turned ON for the fluorescent intensity measuring instrument 2, illustrated in FIG. 3, and, in Step S203, the excitation beam is emitted from the light source 10. Following this, in Step S204, the gas flow of the air that includes the microorganism particles that are subjects to be detected is caused to flow toward the focal point of the excitation beam. In Step S205, the fluorescent intensity measuring instrument 2 uses the first photodetecting element 20A to measure the fluorescent intensity at a first wavelength. Moreover, simultaneously with Step S205, in Step S206 the fluorescent intensity measuring instrument 2 uses the second photodetecting element 20B to measure the fluorescent intensity at the second wavelength. The details of the method for measuring the fluorescent intensity in Step S205 and Step S206 are, for example, as explained in FIG. 4.

In Step S207, the fluorescent intensity measuring instrument 2 saves, to the optical intensity storing devices 24A and 24B, the fluorescent intensity at the first wavelength and the fluorescent intensity at the second wavelength, derived from the microorganism particles that are subjects to be detected. In Step S208, the relative value calculating portion 301 reads out, from the optical intensity storing devices 24A and 24B, a value for the fluorescent intensity at the first wavelength and a value for the fluorescent intensity at the second wavelength, and, for example, calculates a reference value RT for the microorganism particle that is a subject to be detected, by dividing the fluorescent intensity value I₁ at the first wavelength by the fluorescent intensity value I₂ at the second wavelength, as in Equation (1), below:

R_{T}=I₁/I₂ (1)

In Step S209, the relative value calculating portion 301 saves, into the reference value storing device 351, the reference value that has been calculated. In Step S210, the relative value calculating portion 301 evaluates whether or not calculation of the reference values should be terminated. For example, if there is a request to acquire the reference values multiple times and to calculate an average, then this relative value calculating portion 301 will evaluate whether or not the reference values have been acquired the number of times that is necessary for calculating the average. If the reference values have not been acquired the number of times that are necessary in order to calculate an average, processing returns to Step S204. When reference values have been acquired the number of times required for calculating the average, then processing advances to Step S211.

In Step S211, the relative value calculating portion 301 reads out the plurality of reference values from the reference value storing device 351, to calculate the average of the reference values. In Step S212, the relative value calculating portion 301 calculates the standard deviation σ of the reference values. Moreover, in Step S212, the relative value calculating portion 301 calculates a value Wσ wherein the standard deviation σ of the reference values is multiplied by a prescribed constant. The relative value calculating portion 301, in Step S214, defines as an equivalent range for reference values, the range from the reference value-Wσ/2 to the reference value+Wσ/2, and stores it in the reference value storing device 351. For example, using the method described above, the reference value for the microorganism particle that is a subject to be detected, and the equivalent range for the reference value, are saved in the reference value storing device 351. Note that reference values for microorganism particles that are subjects to be detected, acquired using another particle detecting device, instead may be stored into the reference value storing device 351 illustrated in FIG. 1 and FIG. 3.

Moreover, when acquiring a reference value R_{N} of a non-organism particle that is not a subject to be detected, then, in Step S201 in FIG. 6, clean air, from which impurities have been eliminated, is prepared, and the non-organism particles that are not subjects to be detected are included therein.

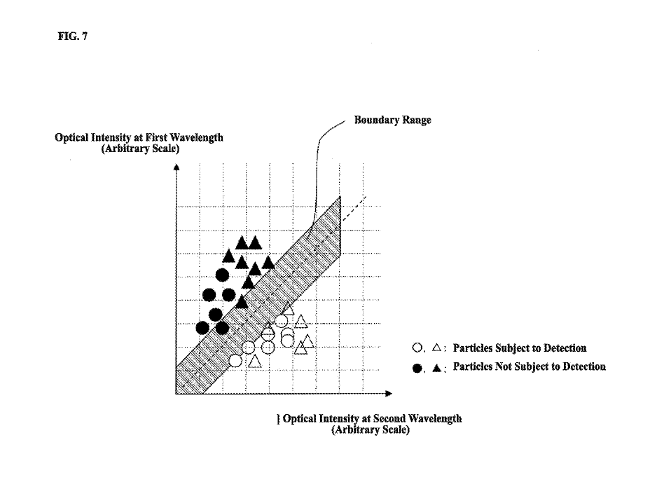

The boundary range for distinguishing between fluorescent particles that are subjects to be detected and particles that are not subjects to be detected, stored in the boundary range storing device 350 illustrated in FIG. 3, is positioned between the range wherein the intensities of light emitted from fluorescent particles that are subjects to be detected are plotted and the range wherein the intensities of light emitted from particles that are not subjects for detection are plotted, has illustrated in, for example, FIG. 7. The boundary range is given by, for example, the following Equation (2):

Y=R_{B}X+H (2)

The Y is a variable that gives the optical intensity at the first wavelength, and X is a variable that gives the optical intensity at the second wavelength. R_{B}, as shown in Equation (3), below, for example, is larger than the reference value R_{T} and smaller than the reference value R_{N}. RB may assume a prescribed value within a range that satisfies Equation (3). H may also assume a value within the prescribed range. The prescribed range is demarcated as illustrated in FIG. 7 by R_{B} and H each giving respective values within the prescribed range.

R_{T}<R_{B}<R_{N} (3)

When the particle detecting device 1, illustrated in FIG. 1, begins to draw in air that is to be tested for an unknown substance that is included in the clean room 70, an excitation beam is directed by the light source 10, illustrated in FIG. 3, toward the air that is drawn in, and the fluorescent intensity measuring instrument 2 measures the intensity of light in the fluorescent band at the first wavelength and the intensity of light in the fluorescent band at the second wavelength, and stores these in the optical intensity storing devices 24A and 24B. The relative value calculating portion 301 reads out, from the optical intensity storing devices 24A and 24B, the value for the optical intensity at the first wavelength and the value for the optical intensity at the second wavelength. Furthermore, the relative value calculating portion 301 calculates the measured relative value by dividing the value of the optical intensity at the first wavelength by the value of the optical intensity at the second wavelength, for example. Note that the method used for calculating the relative value is the same as the method used for calculating the reference value. The reference value calculating portion 301 stores the calculated measured relative value into the relative value storing device 352.

The evaluating portion 302 illustrated in FIG. 3 reads out the measured relative value from the relative value storing device 352, reads the equivalent range for the reference values from the reference value storing device 351, and reads out the boundary range from the boundary range storing device 350. Following this, the evaluating portion 302 evaluates whether or not the measured relative value is within that the boundary range. If the measured relative value is within the boundary range, then the evaluating portion 302 determines that it is not possible to evaluate whether the air that has been drawn in from the clean room 70 includes microorganism particles that are subjects to be detected or non-organism particles that are not subjects to be detected.

If the measured relative value is outside of the boundary range, then the evaluating portion 302 evaluates whether or not the measured relative value is included within the equivalent range for a reference value for a microorganism particle that is a subject to be detected. If the measured relative value is included in the equivalent range for a reference value of a microorganism particle that is a subject to be detected, then the evaluating portion 302 evaluates that a microorganism particle that is a subject to be detected is included in the air that is drawn in from the clean room 70.

If the measured relative value is not included in the equivalent range for the reference value for the prescribed microorganism particles, then the evaluating portion 302 evaluates that the prescribed microorganism particle is not included in the air that has been drawn in. Furthermore, the evaluating portion 302 evaluates whether or not the measured relative value is within the equivalent range for the reference values for the non-organism particles that are not subjects to be detected. If the measured relative value is included in the equivalent range for the reference values of the non-organism particles that are not subjects to be detected, then the evaluating portion 302 evaluates that the air that has been drawn in from the clean room 70 includes non-organism particles that are not subjects to be detected.

The evaluating portion 302 saves the evaluation result in the evaluation result storing device 353, and outputs the evaluation result to an outputting device 401, such as a displaying device or a printer, or the like.

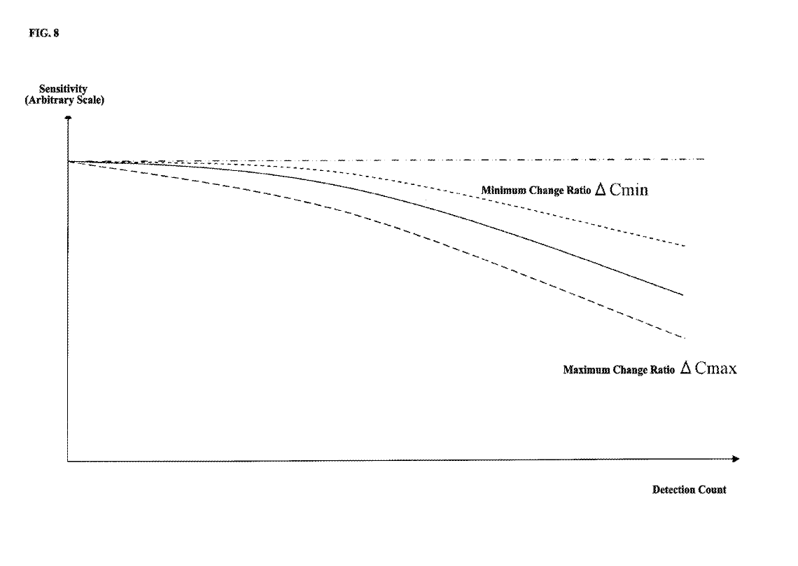

Here, as illustrated in FIG. 8, the first photodetecting element 20A of the fluorescent intensity measuring instrument 2 may break down each time light in the fluorescent band of the first wavelength is detected. Moreover, the photodetection sensitivity of the second photodetecting element 20B of the fluorescent intensity measuring instrument 2 may break down with each detection of light in the fluorescent band at the second wavelength. While the fluorescent intensity measuring instrument 2 is operating, the number of times the first photodetecting element 20A has detected light in the fluorescent band at the first wavelength and the number of times that the second photodetecting element 20B has detected light in the fluorescent band at the second wavelength do not necessarily match each other. Because of this, a state may be produced wherein the degree of breakdown of the sensitivity of the first photodetecting element 20A and the degree of breakdown of the sensitivity of the second photodetecting element 20B in the fluorescent intensity measuring instrument 2 do not match each other.

Moreover, even if the number of times that light in the fluorescent band at the first wavelength has been detected by the first photodetecting element 20A and the number of times that light in the fluorescent band at the second wavelength has been detected by the second photodetecting element 20B were the same, still a state may be produced, due to structural differences between the first photodetecting element 20A and the second photodetecting element 20B, wherein the degree of breakdown of the sensitivity of the first photodetecting element 20A and the degree of breakdown of the sensitivity of the second photodetecting element 20B may not match each other.

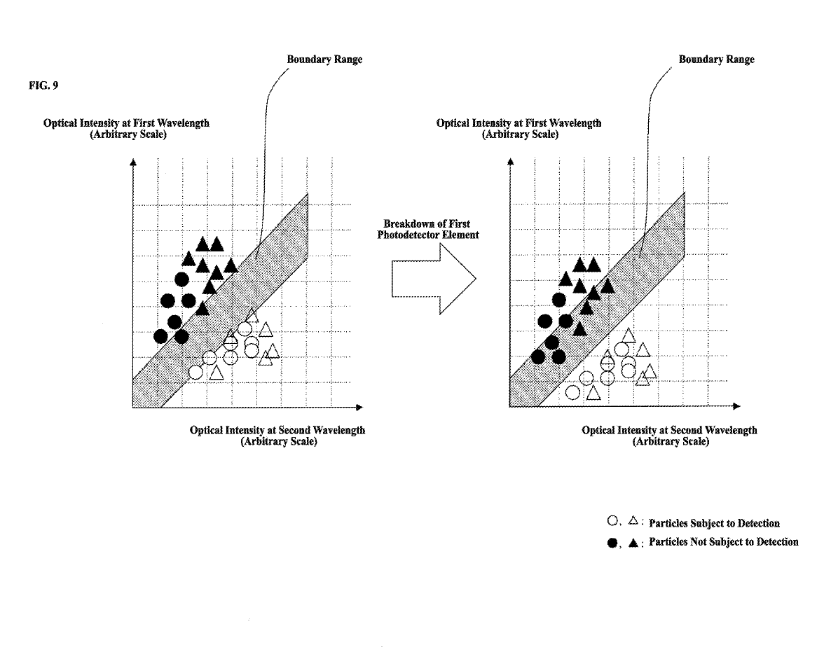

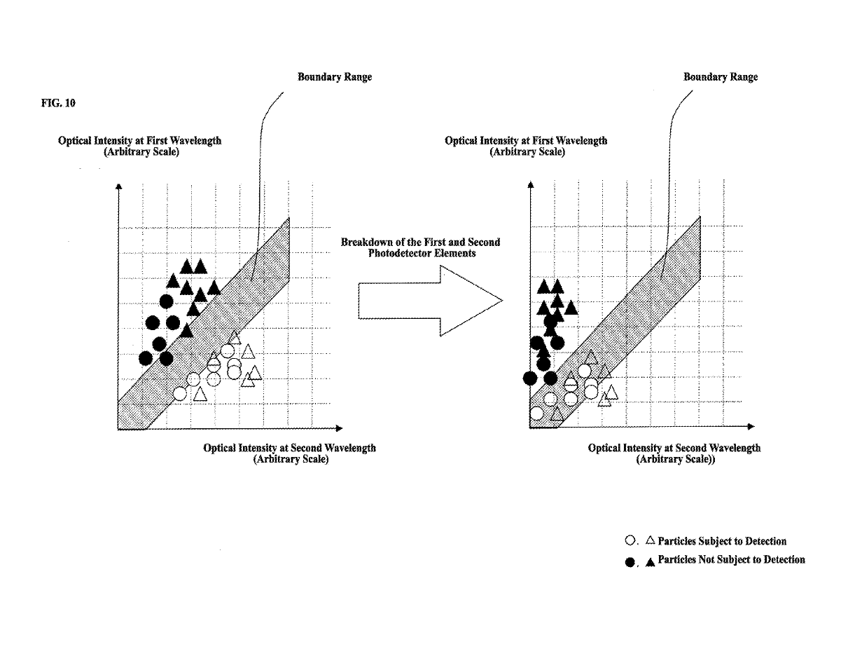

For example, in FIG. 9 the graph on the left shows the correlations between the intensities of light in the fluorescent band emitted by the various particles, measured in a state where the sensitivity has broken down in neither the first photodetecting element 20A nor the second photodetecting element 20B. Here if, for example, the first photodetecting element 20A were to break down thereafter while the second photodetecting element 20B has not broken down, then, as illustrated in the graph on the right, the measured value for the optical intensity at the first wavelength would decline. Conversely, if, for example, both the first photodetecting element 20A and the second photodetecting element 20B were to break down, then, as shown in the graph on the right in FIG. 10, the measured value for the optical intensity at the first wavelength and the measured value for the optical intensity at the second wavelength would both decline, but the amounts by which they decline may not necessarily match each other.

Consequently, when compared to the time at which the boundary range, saved in the boundary range storing device 350, illustrated in FIG. 3, was demarcated, it may become impossible, at the time of acquiring the measured relative value for the air that is to be tested, to correctly evaluate whether or not a fluorescent particle that is a subject to be detected is included in the air, even when evaluating whether or not the measured relative value is within the boundary range, because there is no correction in accordance with the breakdown if there has been breakdown in the first photodetecting element 20A and/or the second photodetecting element 20B.

In this regard, the correcting portion 303 corrects the boundary range, which is stored in the boundary range storing device 350, in accordance with the states of the light source 10 and the fluorescent intensity measuring instrument 2. In the present example, an explanation will be given for an example wherein the correcting portion 303 corrects the boundary range that is stored in the boundary range storing device 350, in accordance with the number of times that light in the fluorescent band at the first wavelength has been detected by the first photodetecting element 20A and the number of times wherein light in the fluorescent band at the second wavelength has been detected by the second photodetecting element 20B.

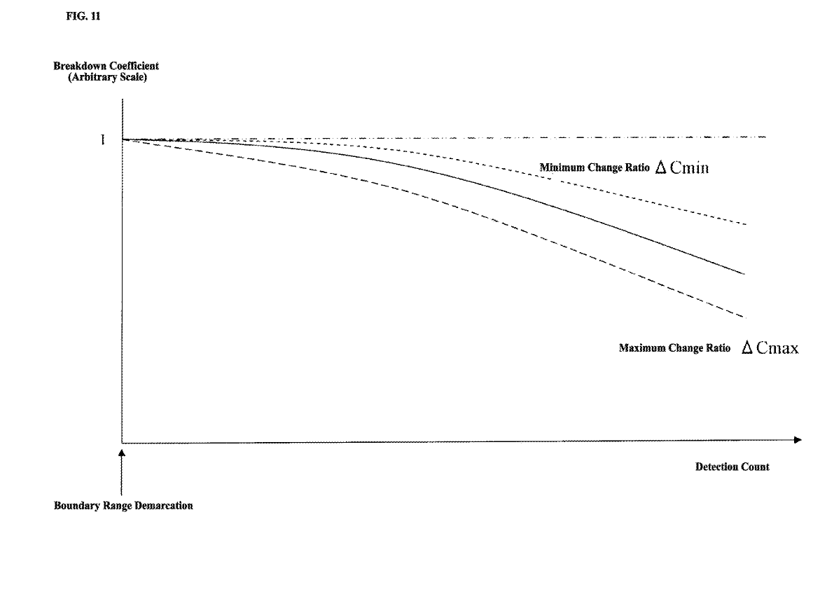

The relationship between the number of times that light has been detected by the first photodetecting element 20A and the second photodetecting element 20B, respectively, and the breakdowns of sensitivity therein can be acquired by performing inspections in advance. Additionally, as illustrated in FIG. 11, if the sensitivity of the first photodetecting element 20A at the time of demarcation of the boundary range is normalized to 1, then the sensitivity that breaks down thereafter can be defined as a breakdown coefficient. The curve illustrated in FIG. 11 can be approximated as a first function with the number of times that light has been detected by the first photodetecting element 20A as the independent variable and the breakdown coefficient as the dependent variable. For the second photodetecting element 20B as well, a second function can be acquired in advance with the number of times that light has been detected as the independent variable and the breakdown coefficient as the dependent variable. A breakdown degree storing device 355 is connected to the CPU 300 that is illustrated in FIG. 3. The first function and the second function, acquired in advance, are stored in the breakdown degree storing device 355.

The correcting portion 303 reads out, from the monitoring result storing device 354, the number of times that light in the fluorescent band at the first wavelength has been detected by the first photodetecting element 20A and the number of times that light in the fluorescent band at the second wavelength has been detected by the second photodetecting element 20B. Additionally, the correcting portion 303 reads out the first function and the second function from the breakdown degree storing device 355. Next the correcting portion 303 substitutes the number of times that light has been detected by the first photodetecting element 20A into the independent variable of the first function, to calculate the breakdown coefficient F1 for the first photodetecting element 20A. Additionally, the correcting portion 303 substitutes the number of times that light has been detected by the second photodetecting element 20B into the independent variable for the second function to calculate the breakdown coefficient F₂ of the second photodetecting element 20B.

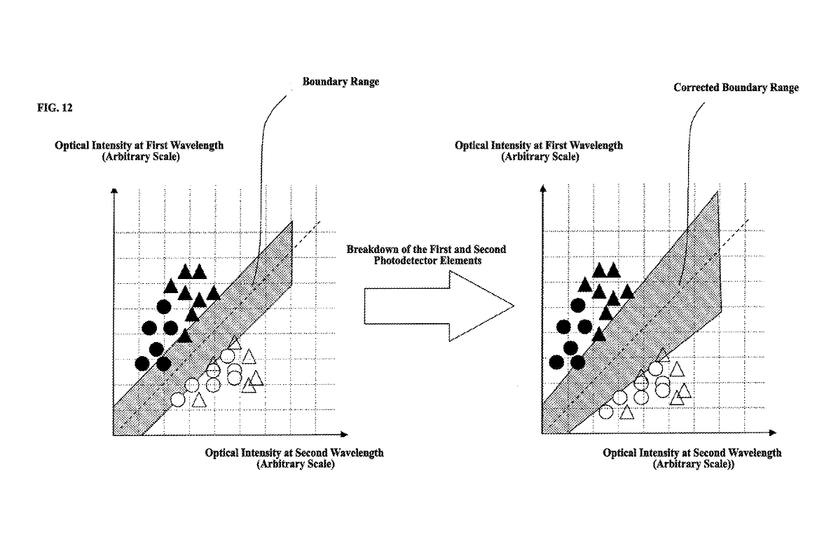

The correcting portion 303 reads out, from the boundary range storing device 350, the boundary range given by, for example, Equation (2), above, and, as illustrated in Equation (4), below, multiplies the coefficient RB by a value wherein F1 has been divided by F2, to calculate a corrected coefficient RBC, to demarcate a corrected boundary range, given by Equation (5), below. FIG. 12 is one example of a corrected boundary range. The correcting portion 303 saves the stores boundary range in the boundary range storing device 350.

R_{BC}=R_{B}×(F1/F2) (4)

Y=R_{B}cX+H (5)

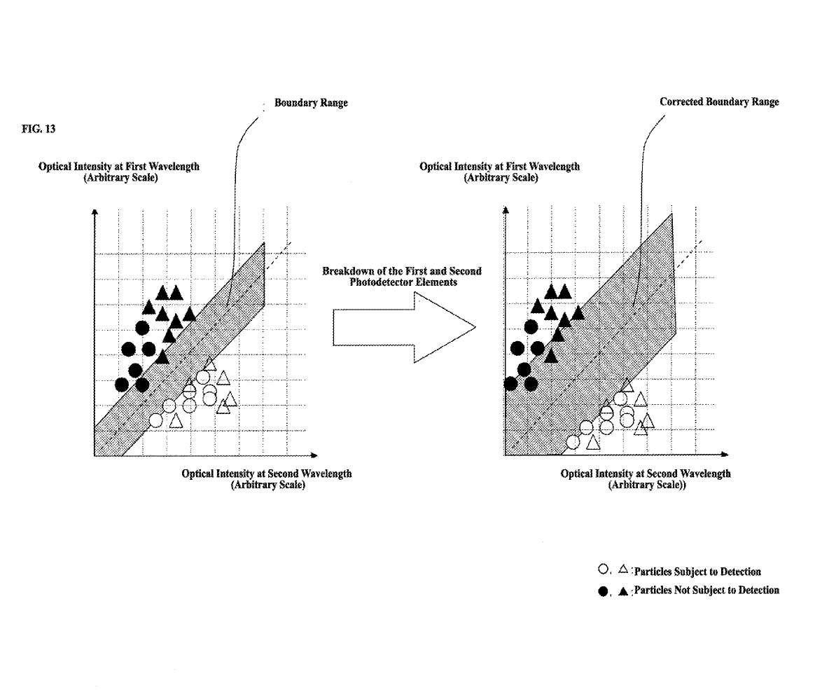

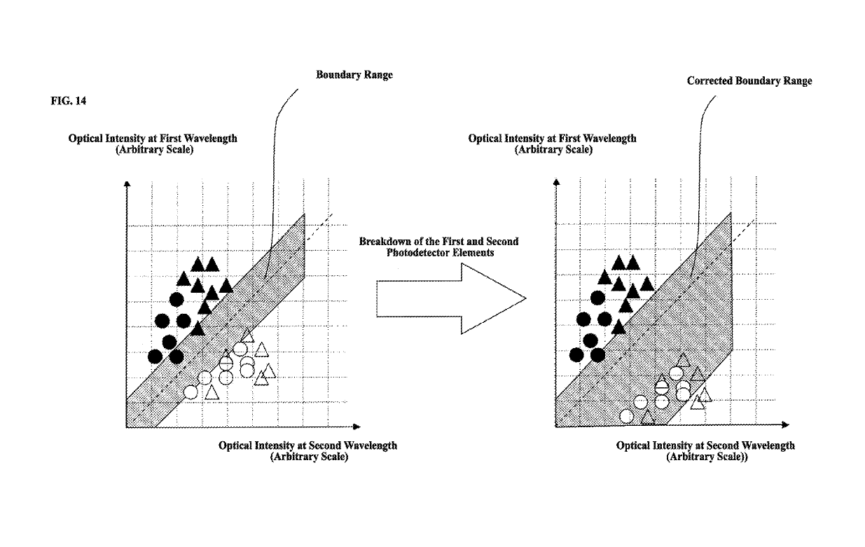

Note that the correction to the boundary range is not limited to the method described above. For example, the value for H in Equation (2) may be corrected instead, as illustrated in FIG. 13 and FIG. 14.

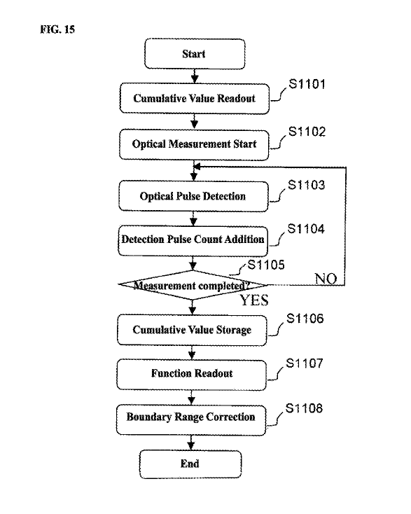

FIG. 15 is a flowchart illustrating a method by which the correcting portion 303 corrects the boundary range. When the particle detecting device 1, illustrated in FIG. 1, commences drawing in the air that is to be tested for an unknown substance from the clean room 70, then, in Step S1101, the monitoring portion 304, illustrated in FIG. 3, reads out, from the monitoring result storing device 354, the number of times that light in the fluorescent band at the first wavelength has been detected by the first photodetecting element 20A and the number of times that light in the fluorescent band at the second wavelength has been detected by the second photodetecting element 20B. In Step S1102, the light source 10 emits the excitation beam, and in Step S1103, the fluorescent intensity measuring device 2 measures the intensity of the light in the fluorescent band at the first wavelength, emitted by the substance in the air, and measures the intensity of the light in the fluorescent band at the second wavelength.

When, in Step S1103, the first photodetecting element 20A detects one pulse of light in the fluorescent band at the first wavelength, then, in Step S1104, the monitoring portion 304 adds 1 to the number of times that the first photodetecting element 20A has, to that point, detected light in the fluorescent band at the first wavelength. Moreover when, in Step S1103, the second photodetecting element 20B detects one pulse of light in the fluorescent band at the second wavelength, then, in Step S1104, the monitoring portion 304 adds 1 to the number of times that the second photodetecting element 20B has, to that point, detected light in the fluorescent band at the second wavelength.

The monitoring portion 304 in Step S1105 evaluates whether or not the measurements for the light in the fluorescent band have been completed. If the measurements for the light in the fluorescent band have not been completed, then processing returns to Step S1103. If the measurements for the light in the fluorescent band have been completed, then processing advances to Step S1106. In Step S1106, the monitoring portion 304 updates the number of times that the light in the fluorescent band at the first wavelength has been detected by the first photodetecting element 20A and the number of times that light in the fluorescent band of the second wavelength has been detected by the second photodetecting element 20B, saved in the monitoring result storing device 354. As a result, the cumulative number of times that light in the fluorescent band of the first wavelength has been detected by the first photodetecting element 20A and the cumulative number of times that light in the fluorescent band at the second wavelength has been detected by the second photodetecting element 20B are saved in the monitoring result storing device 354.

In Step S1107, the correcting portion 303 reads out, from the monitoring result storing device 354, the number of times that light in the fluorescent band of the first wavelength has been detected by the first photodetecting element 20A and the number of times that light in the fluorescent band of the second wavelength has been detected by the second photodetecting element 20B. Additionally, the correcting portion 303 reads out the first function and the second function from the breakdown degree storing device 355. In Step S1108, the correcting portion 303 substitutes the number of times that light has been detected by the first photodetecting element 20A into the independent variable in the first function, to calculate the breakdown coefficient for the first photodetecting element 20A. Additionally, the correcting portion 303 substitutes the number of times that light has been detected by the second photodetecting element 20B into the independent variable for the second function to calculate the breakdown coefficient of the second photodetecting element 20B. Moreover, the correcting portion 303 reads out the boundary range from the boundary range storing device 350, and, based on the calculated breakdown coefficient, corrects the boundary range and stores it in the boundary range storing device 350.

When the correcting portion 303 has corrected the boundary range, then the evaluating portion 302 evaluates whether or not the measured value is within the corrected boundary range.

The particle detecting device 1 according to the present example, as explained above, is able to suppress false detection of a substance as a microorganism particle that is a subject to be detected, even when light in the fluorescent band is produced through illumination of the substance with an excitation beam when a substance other than the prescribed microorganism particles that are subjects to be detected is included in the fluid that is subject to inspection. Moreover, even if there is a breakdown in the fluorescent intensity measuring instrument 2 between the demarcation of the boundary range and the acquisition of the measured relative value, the boundary range is corrected, making it possible to prevent false evaluations. Because of this, the particle detecting device 1 according to the present example is able to detect accurately the microorganism particles that are subjects to be detected.

### First Modified Example

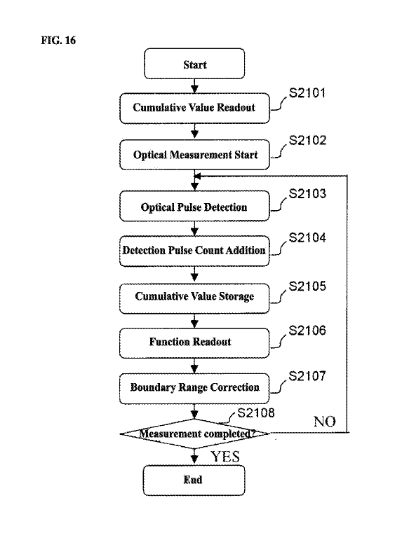

The method by which the correcting portion 303 corrects the boundary range is not limited to that which is illustrated in FIG. 15, but rather may use, for example, the method illustrated in FIG. 16. Step S2101 through Step S2104 of FIG. 16 are identical to Step S1101 through Step S1104 in FIG. 15.

In the method illustrated in FIG. 16, in Step S2104, when the monitoring portion 1 has increased by 1 the number of times that light in the fluorescent band of the first wavelength has been detected by the first photodetecting element 20A, processing advances to Step S2105, where the monitoring portion 304 updates the number of times that light in the fluorescent band of the first wavelength has been detected by the first photodetecting element 20A, stored in the monitoring result storing device 354. Moreover, in Step S2104, when the monitoring portion 304 has increased by 1 the number of times that light in the fluorescent band of the second wavelength has been detected by the second photodetecting element 20B, processing advances to Step S2105, where the monitoring portion 304 updates the number of times that light in the fluorescent band of the second wavelength has been detected by the second photodetecting element 20B, stored in the monitoring result storing device 354.

Step S2106 and Step S2107 in FIG. 16 are identical to Step S1107 and Step S1108 in FIG. 15. In Step S2108, the monitoring portion 304 evaluates whether or not the measurements for light in the fluorescent band have been completed. If the measurements of light and fluorescent band have not yet been completed, then processing returns to Step S2103. In the method explained above, the boundary range is corrected each time light is detected by either the first photodetecting element 20A or the second photodetecting element 20B. Because of this, it is possible to correct, in real time, the boundary range during the detection of multiple particles.

### Second Modified Example

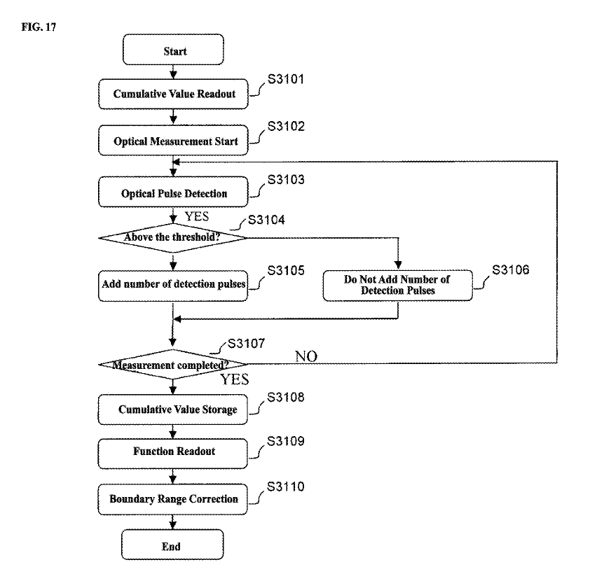

The method by which the correcting portion 303 corrects the boundary range may instead be, for example, a method as illustrated in FIG. 17. Step S3101 through Step S3103 of FIG. 17 are identical to Step S1101 through Step S1103 in FIG. 15.

In Step S3103 in FIG. 17, when the first photodetecting element 20A detects a pulse of light in the fluorescent band of the first wavelength, then, in Step S3104, the monitoring portion 304 evaluates whether or not the intensity of the light that has been detected is above a threshold value. If the above the threshold value, then processing advances to Step S3105, where the monitoring portion 304 adds 1 to the number of times that light in the fluorescent band at the first wavelength has been detected by the first photodetecting element 20A. If below the threshold value, then processing advances to Step S3106, and the monitoring portion 304 does not add anything to the number of times that light in the fluorescent band at the first wavelength has been detected by the first photodetecting element 20A.

Moreover, in Step S3103 in FIG. 17, when the second photodetecting element 20B detects a pulse of light in the fluorescent band of the second wavelength, then, in Step S3104, the monitoring portion 304 evaluates whether or not the intensity of the light that has been detected is above a threshold value. If the above the threshold value, then processing advances to Step S3105, where the monitoring portion 304 adds 1 to the number of times that light in the fluorescent band at the second wavelength has been detected by the first photodetecting element 20B. If below the threshold value, then processing advances to Step S3106, and the monitoring portion 304 does not add anything to the number of times that light in the fluorescent band at the second wavelength has been detected by the second photodetecting element 20B.

Step S3107 through Step S3110 of FIG. 17 are identical to Step S1105 through Step S1108 in FIG. 15. The threshold value in Step S3104 may use an average offset, and the variability of the offset added to the average offset may be used as the value to be added. The average and variability of the offset may be measured in advance. Furthermore, the average and variability of the offset may be measured in real time during particle detection. Conversely, the threshold value in Step S3104 may be an average peak value or a maximum peak value of the shot noise pulses in the photoelectron multiplier tube, acquired in advance. The threshold values may be set separately for the first wavelength and the second wavelength.

### Third Modified Example

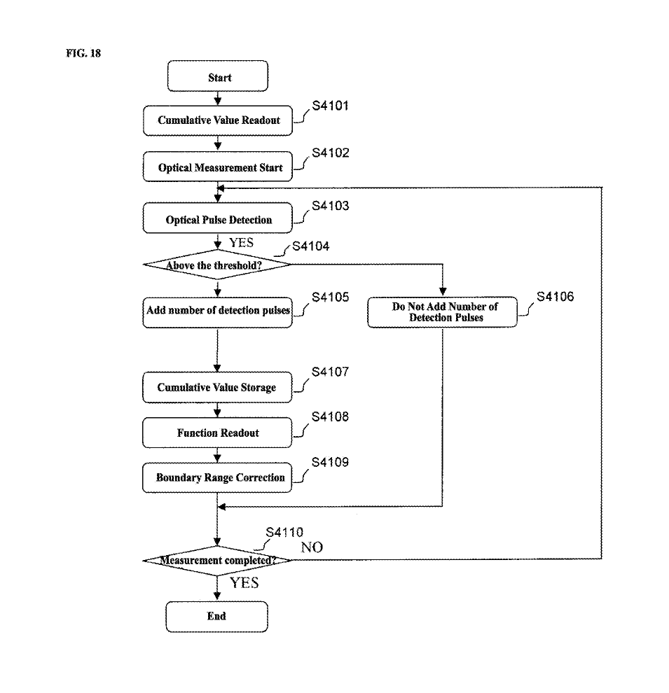

The method by which the correcting portion 303 corrects the boundary range may instead be, for example, a method as illustrated in FIG. 18. Step S4101 through Step S4106 of FIG. 18 are identical to Step S3101 through Step S3106 in FIG. 17.

In the method illustrated in FIG. 18, in Step S4105, when the monitoring portion 304 has incremented by 1 the number of times that light in the fluorescent band of the first wavelength has been detected by the first photodetecting element 20A, processing advances to Step S4107, where the monitoring portion 304 updates the number of times that light in the fluorescent band of the first wavelength has been detected by the first photodetecting element 20A, stored in the monitoring result storing device 354. Moreover, in Step S4105, when the monitoring portion 304 has incremented by 1 the number of times that light in the fluorescent band of the second wavelength has been detected by the second photodetecting element 20B, processing advances to Step S4107, where the monitoring portion 304 updates the number of times that light in the fluorescent band of the second wavelength has been detected by the second photodetecting element 20B, stored in the monitoring result storing device 354.

Step S4108 and Step S4109 in FIG. 18 are identical to Step S3109 and Step S3110 in FIG. 17. In Step S4110, the monitoring portion 304 evaluates whether or not the measurements for light in the fluorescent band have been completed. If the measurements of light and fluorescent band have not yet been completed, then processing returns to Step S4103. In the method explained above, the boundary range is corrected each time light is detected by either the first photodetecting element 20A or the second photodetecting element 20B. Because of this, it is possible to correct, in real time, the boundary range during the detection of multiple particles.

### Fourth Modified Example

In a fourth modified example according to the present example, the monitoring portion 304, illustrated in FIG. 3, calculates the amplitude of the detected pulse each time that light in the fluorescent band of the first wavelength is detected by the first photodetecting element 20A, and saves it to the monitoring result storing device 354. Moreover, the monitoring portion 304 calculates the amplitude of the detected pulse each time that light in the fluorescent band of the second wavelength is detected by the second photodetecting element 20B, and stores it to the monitoring result storing device 354. The calculated values for the amplitudes of the pulses that have been detected reflect the calculated intensities of the lights that have been detected.

The relationships between the calculated values for the respective pulse amplitudes of the lights that are detected by the first photodetecting element 20A and the second photodetecting element 20B and the breakdowns in sensitivity can be acquired through testing in advance. Because of this, a function having the calculated pulse amplitude for the light that is detected by the first photodetecting element 20A as an independent variable and the breakdown coefficient as the dependent variable may be defined as a first function, and a function having the calculated pulse amplitude for the light that is detected by the second photodetecting element 20B as an independent variable and the breakdown coefficient as the dependent variable may be defined as a second function.

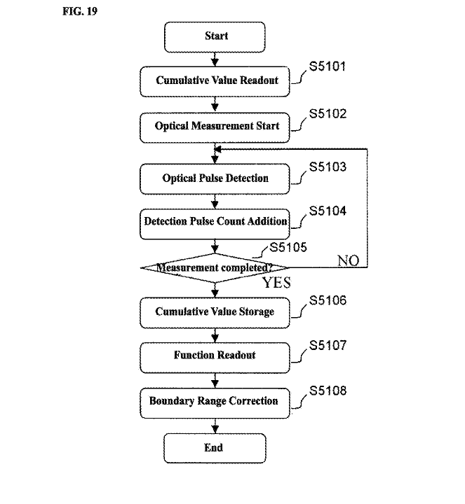

A flowchart for the correction of the boundary range by the correcting portion 303 relating to the fourth modified example according to the present example is shown in FIG. 19. When the particle detecting device 1 illustrated in FIG. 1 begins to draw in air that is to be tested for an unknown substance that is included in the clean room 70, then, in Step S5101, the monitoring portion 304 reads out, from the monitoring result storing device 354, the calculated value for the amplitude of the pulse of the light in the fluorescent band at the first wavelength, detected by the first photodetecting element 20A, and the calculated value for the amplitude of the pulse of the light in the fluorescent band at the second wavelength, detected by the second photodetecting element 20B. In Step S5102, the light source 10 emits the excitation beam, and, in Step S5103, the fluorescent intensity measuring instrument 2 measures the intensity of the light in the fluorescent band at the first wavelength, and measures the intensity of light in the fluorescent band at the second wavelength.

In Step S5103, when a pulse of light in the fluorescent band of the first wavelength is detected by the first photodetecting element 20A, then, in Step S5104, the monitoring portion 304 adds, to the calculated amplitude of the pulse of the light in the fluorescent band of the first wavelength that has been detected thus far by the first photodetecting element 20A the amplitude of the pulse of light detected in this cycle. Moreover, in Step S5103, when a pulse of light in the fluorescent band of the second wavelength is detected by the second photodetecting element 20B, then, in Step S5104, the monitoring portion 304 adds, to the calculated amplitude of the pulse of the light in the fluorescent band of the second wavelength that has been detected thus far by the second photodetecting element 20B the amplitude of the pulse of light detected in this cycle.

In Step S5105, the monitoring portion 304 evaluates whether or not the measurements for light in the fluorescent band have been completed. If the measurements for the light in the fluorescent band have not been completed, then processing returns to Step S5103. If the measurements for the light in the fluorescent band have been completed, then processing advances to Step S5106. In Step S5106, the monitoring portion 304 updates the integral value of the magnitudes of the pulses of light in the fluorescent band at the first wavelength has been detected by the first photodetecting element 20A and the integral value of the magnitudes of the pulses of light in the fluorescent band of the second wavelength has been detected by the second photodetecting element 20B, saved in the monitoring result storing device 354.

In Step S5107, the correcting portion 303 reads out the integral value of the magnitudes of the pulses of light in the fluorescent band at the first wavelength has been detected by the first photodetecting element 20A and the integral value of the magnitudes of the pulses of light in the fluorescent band of the second wavelength has been detected by the second photodetecting element 20B, from the monitoring result storing device 354. Additionally, the correcting portion 303 reads out the first function and the second function from the breakdown degree storing device 355. In Step S5108, the correcting portion 303 substitutes the integral value of the pulse magnitudes of the light has been detected by the first photodetecting element 20A into the independent variable in the first function, to calculate the breakdown coefficient for the first photodetecting element 20A. Moreover, the correcting portion 303 substitutes the integral value of the pulse magnitudes of the light has been detected by the second photodetecting element 20B into the independent variable in the second function, to calculate the breakdown coefficient for the second photodetecting element 20B. Moreover, the correcting portion 303 reads out the boundary range from the boundary range storing device 350, and, based on the calculated breakdown coefficient, corrects the boundary range and stores it in the boundary range storing device 350.

### Fifth Modified Example

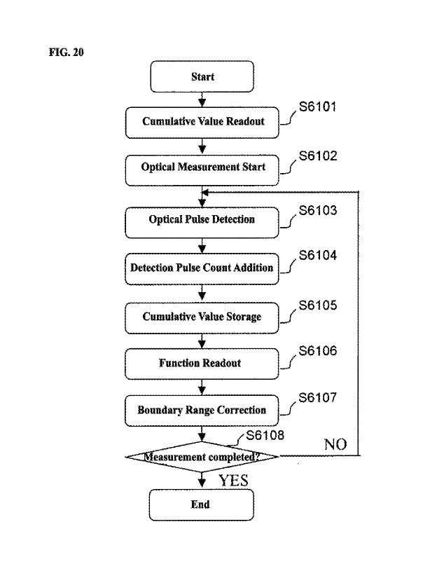

The method by which the correcting portion 303 corrects the boundary range may instead be, for example, a method as illustrated in FIG. 20. Step S6101 through Step S6104 of FIG. 20 are identical to Step S5101 through Step S5104 in FIG. 19.

In the method illustrated in FIG. 20, in Step S6104, when the monitoring portion 304 has added, to the integral value of the peak amplitude of the light, the peak height of the light in the fluorescent band of the first wavelength that has been detected this time by the first photodetecting element 20A, processing advances to Step S6105, where the monitoring portion 304 updates the integral value of the peak amplitudes of the light in the fluorescent band of the first wavelength has been detected by the first photodetecting element 20A, stored in the monitoring result storing device 354. Moreover, in Step S6104, when the monitoring portion 304 has added, to the integral value of the peak amplitude of the light, the peak height of the light in the fluorescent band of the second wavelength that has been detected this time by the second photodetecting element 20B, processing advances to Step S6105, where the monitoring portion 304 updates the integral value of the peak amplitudes of the light in the fluorescent band of the second wavelength has been detected by the second photodetecting element 20B, stored in the monitoring result storing device 354.

Step S6106 and Step S6107 in FIG. 20 are identical to Step S5107 and Step S5108 in FIG. 19. In Step S6108, the monitoring portion 304 evaluates whether or not the measurements for light in the fluorescent band have been completed. If the measurements of light and fluorescent band have not yet been completed, then processing returns to Step S6103. In the method explained above, the boundary range is corrected each time light is detected by either the first photodetecting element 20A or the second photodetecting element 20B. Because of this, it is possible to correct, in real time, the boundary range during the detection of multiple particles.

### Sixth Modified Example

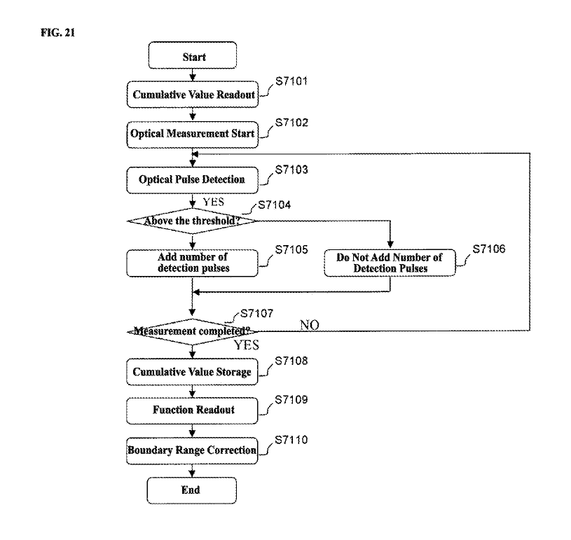

The method by which the correcting portion 303 corrects the boundary range may instead be, for example, a method as illustrated in FIG. 21. Step S7101 through Step S7103 of FIG. 21 are identical to Step S5101 through Step S5103 in FIG. 19.

In Step S7103 in FIG. 21, when the first photodetecting element 20A detects a pulse of light in the fluorescent band of the first wavelength, then, in Step S7104, the monitoring portion 304 evaluates whether or not the peak amplitude of the light that has been detected is above a threshold value. If the above the threshold value, then processing advances to Step S7105, where the monitoring portion 304 adds the peak amplitude of the light detected this time to the integral value of the peak amplitudes of light in the fluorescent band at the first wavelength has been detected by the first photodetecting element 20A. If below the threshold value, then processing advances to Step S7106, and the monitoring portion 304 does not add anything to the integral value of the peak amplitudes of the light in the fluorescent band at the first wavelength has been detected by the first photodetecting element 20A.

Moreover, in Step S7103 in FIG. 17, when the second photodetecting element 20B detects a pulse of light in the fluorescent band of the second wavelength, then, in Step S7104, the monitoring portion 304 evaluates whether or not the peak amplitude of the light that has been detected is above a threshold value. If the above the threshold value, then processing advances to Step S7105, where the monitoring portion 304 adds the peak amplitude of the light detected this time to the integral value of the peak amplitudes of light in the fluorescent band at the second wavelength has been detected by the second photodetecting element 20B. If below the threshold value, then processing advances to Step S7106, and the monitoring portion 304 does not add anything to the integral value of the peak amplitudes of the light in the fluorescent band at the second wavelength has been detected by the second photodetecting element 20B. Step S7107 through Step S7108 of FIG. 21 are identical to Step S5105 through Step S5108 in FIG. 19.

### Seventh Modified Example

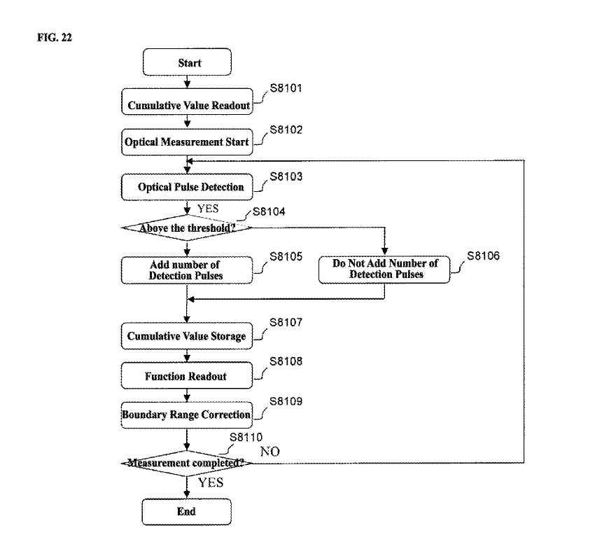

The method by which the correcting portion 303 corrects the boundary range may instead be, for example, a method as illustrated in FIG. 22. Step S8101 through Step S8106 of FIG. 22 are identical to Step S7101 through Step S7106 in FIG. 21.

In the method illustrated in FIG. 22, in Step S8105, when the monitoring portion 304 has added, to the integral value of the peak amplitude of the light, the peak height of the light in the fluorescent band of the first wavelength that has been detected this time by the first photodetecting element 20A, processing advances to Step S8107, where the monitoring portion 304 updates the integral value of the peak amplitudes of the light in the fluorescent band of the first wavelength has been detected by the first photodetecting element 20A, stored in the monitoring result storing device 354. Moreover, in Step S8105, when the monitoring portion 304 has added, to the integral value of the peak amplitude of the light, the peak height of the light in the fluorescent band of the second wavelength that has been detected this time by the second photodetecting element 20B, processing advances to Step S8101, where the monitoring portion 304 updates the peak amplitude of the light in the fluorescent band of the second wavelength has been detected by the second photodetecting element 20B, stored in the monitoring result storing device 354.

Step S8108 and Step S8109 in FIG. 22 are identical to Step S7109 and Step S7110 in FIG. 21. The monitoring portion 304 in Step S8110 evaluates whether or not the measurements for the light in the fluorescent band have been completed. If the measurements of light and fluorescent band have not yet been completed, then processing returns to Step S8103. In the method explained above, the boundary range is corrected each time light is detected by either the first photodetecting element 20A or the second photodetecting element 20B. Because of this, it is possible to correct, in real time, the boundary range during the detection of multiple particles.

### Eighth Modified Example

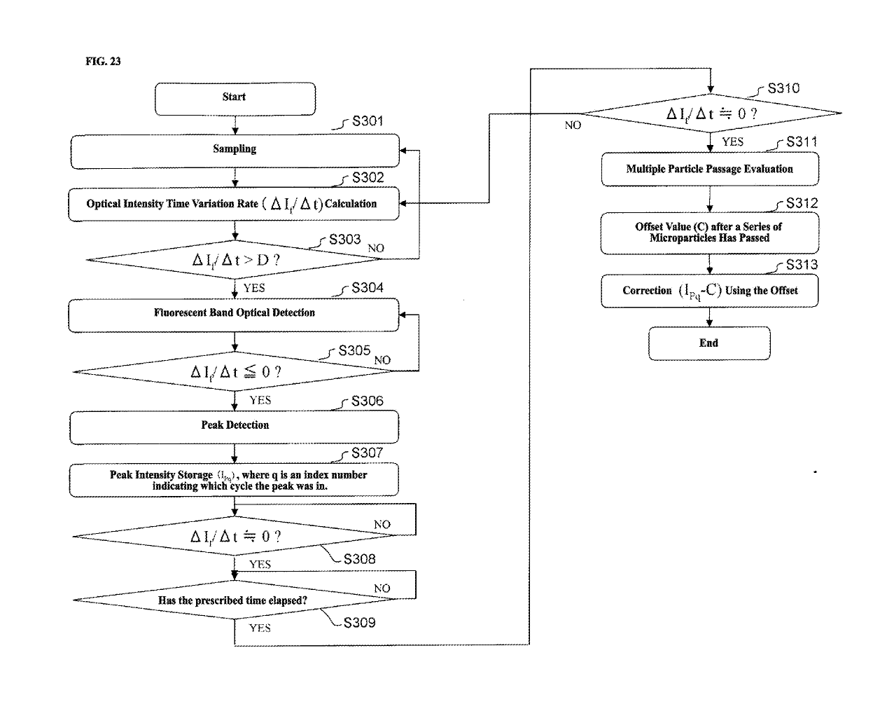

The method by which the fluorescent intensity measuring instrument 2 illustrated in FIG. 3 calculates the intensity of light in the fluorescent band at the first wavelength, using the first photodetecting element 20A, is not limited to the method illustrated in FIG. 4, but rather may be, for example, the method illustrated in FIG. 23.

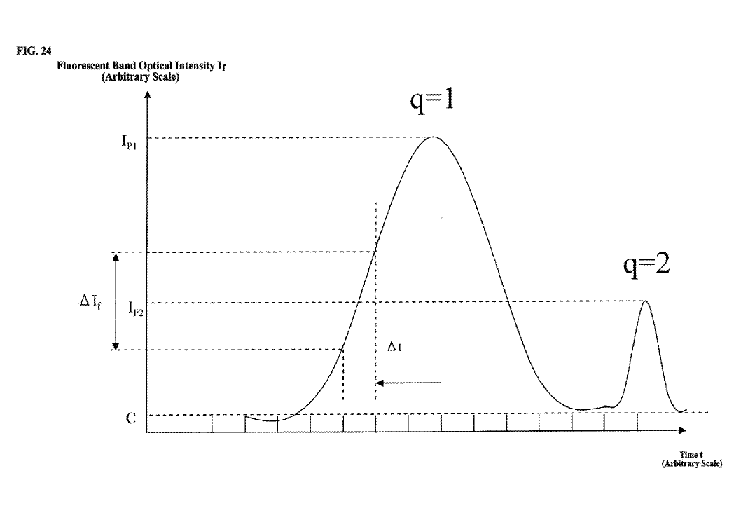

Step S301 through Step S308 of FIG. 23 are executed identically to Step S101 through Step S108 in FIG. 4. However, in Step S307, the optical intensity calculating device 23A stores, to the optical intensity storing device 24A that is included in the fluorescent intensity measuring instrument 2, the intensity of light in the fluorescent band I_{P1} at the first peak, shown in FIG. 24. In Step S309, an evaluation is performed as to whether or not a prescribed time interval has elapsed.

After the prescribed time has elapsed in Step S309, then, in Step S310, the fluorescent intensity measuring instrument 2 evaluates whether or not the rate of change over time Δ_{f}/Δt of the intensity of light in the fluorescent band has gone to near zero.

If the rate of change over time ΔI_{f}/Δt of the intensity of light in the fluorescent band has not gone to near zero, then, as illustrated in FIG. 24, the evaluation is that a second peak has appeared, and processing returns to Step S302, where Step S303 through Step S306 are executed, and, in Step S307, the optical intensity calculating device 23A stores, in the optical intensity storing device 24A that is included in the fluorescent intensity measuring instrument 2, the intensity of light I_{P2} in the fluorescent band at the second peak. After the loop from Step S302 through Step S310 is iterated, then if, in Step S310, the rate of change over time ΔI_{f}/Δt of the intensity of light in the fluorescent band can has reached approximately zero, then the optical intensity calculating device 23A, in Step S311, evaluates that the passage of the plurality of particles or the substance from the position of illumination of the excitation beam has been completed.

In Step S312, the optical intensity calculating device 23A, after having evaluated that the passage of the plurality of particles or the substance has been completed, measures, as an offset C, the intensity of light in the fluorescent band at the first wavelength, detected by the first photodetecting element 20A. In Step S313, the optical intensity calculating device 23A subtracts this offset C from the intensity IP1 of light in the fluorescent band at the first peak, saved in the optical intensity storing device 24A, to calculate the corrected intensity IP1C of the light in the fluorescent band at the first peak, and stores this in the optical intensity storing device 24A as the intensity of light in the fluorescent band at the first wavelength.

Moreover, In Step S313, the optical intensity calculating device 23A subtracts this offset C from the intensity I_{P2} of light in the fluorescent band at the second peak, saved in the optical intensity storing device 24A, to calculate the corrected intensity I_{P2C} of the light in the fluorescent band at the second peak, and stores this in the optical intensity storing device 24A as the intensity of light in the fluorescent band at the first wavelength.

The method described above enables the intensity of light at the respective peaks of a plurality of substances to be measured. Note that the method by which the fluorescent intensity measuring instrument 2 calculates, and saves in the optical intensity storing device 24B, the intensity of light in the fluorescent band at the second wavelength, using the second photodetecting element 20B, is identical to the method described above, so the explanation thereof will be omitted.

### Ninth Modified Example

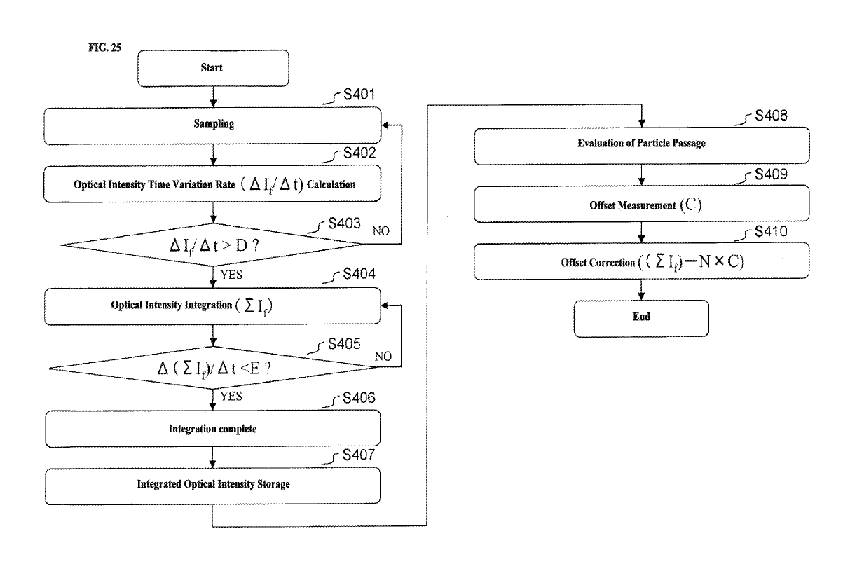

The method by which the fluorescent intensity measuring instrument 2, illustrated in FIG. 3, calculates the intensity of light in the fluorescent band at the first wavelength, using the first photodetecting element 20A, may instead, for example, be the method illustrated in FIG. 25.

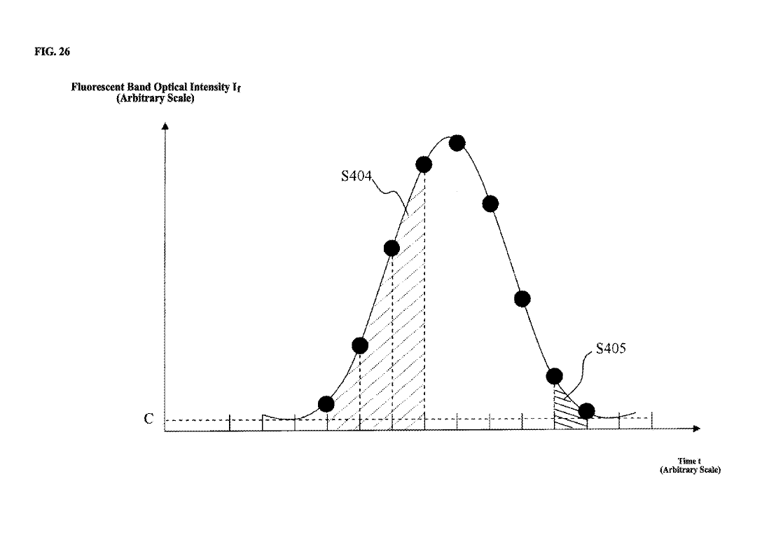

Step S401 through Step S403 of FIG. 25 are executed identically to Step S101 through Step S103 in FIG. 4. In Step S403 of FIG. 25, if the rate of change over time ΔI_{f}/Δt of the intensity of light in the fluorescent band detected by the first photodetecting element 20A is greater than a prescribed threshold value D, processing advances to Step S404, where the optical intensity calculating device 23A, as illustrated in FIG. 26, commences calculation of an integral value for the intensity of light in the fluorescent band. In Step S405, the optical intensity calculating device 23A evaluates whether or not the rate of change over time in the integral value of the intensity of light in the fluorescent band is below a prescribed threshold value E. If the rate of change over time in the integral value is below the prescribed threshold value E, then processing returns to Step S404, and the calculation of the integral value is continued.

In Step S405, if, as illustrated in FIG. 26, the rate of change over time in the integral value is less than the prescribed threshold value E, then processing advances to Step S406, where the calculation of the integral value is terminated, and, in Step S407, the integral of the optical intensity is saved into the optical intensity storing device 24A within the fluorescent intensity measuring instrument 2. In Step S408, the optical intensity calculating device 23A evaluates that the particle or substance has passed from the position illuminated by the excitation beam.

In Step S409, the optical intensity calculating device 23A, after evaluating that the particle or substance has passed, measures, as an offset C, the intensity of the light in the fluorescent band at the first wavelength, detected by the first photodetecting element 20A. In Step S410, the optical intensity calculating device 23A subtracts, from the integral value for the intensity of light in the fluorescent band, saved in the optical intensity storing device 24A, N times the offset C, where N is the number of data points when performing the integration, to calculate a corrected integral value for the intensity of light in the fluorescent band, and stores this in the optical intensity storing device 24A as the intensity of light in the fluorescent band at the first wavelength.

The method described above enables easy calculation of the relative value for a substance wherein the intensity of light is weak, using the integral value of the intensity of the light. Note that the method by which the fluorescent intensity measuring instrument 2 calculates, and saves in the optical intensity storing device 24B, the intensity of light in the fluorescent band at the second wavelength, using the second photodetecting element 20B, is identical to the method described above, so the explanation thereof will be omitted.

### Tenth Modified Example

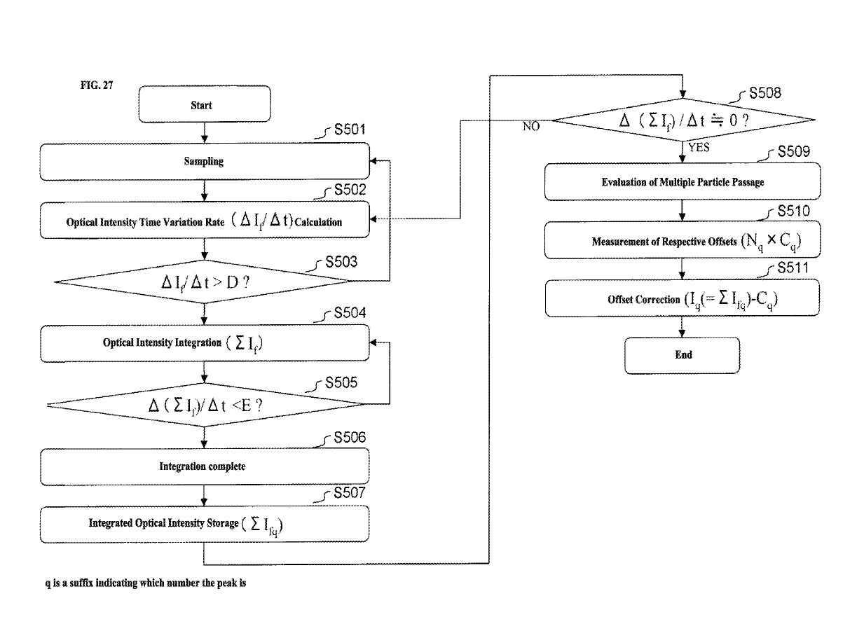

The method by which the fluorescent intensity measuring instrument 2, illustrated in FIG. 3, calculates the intensity of light in the fluorescent band at the first wavelength, using the first photodetecting element 20A, may instead, for example, be the method illustrated in FIG. 27.

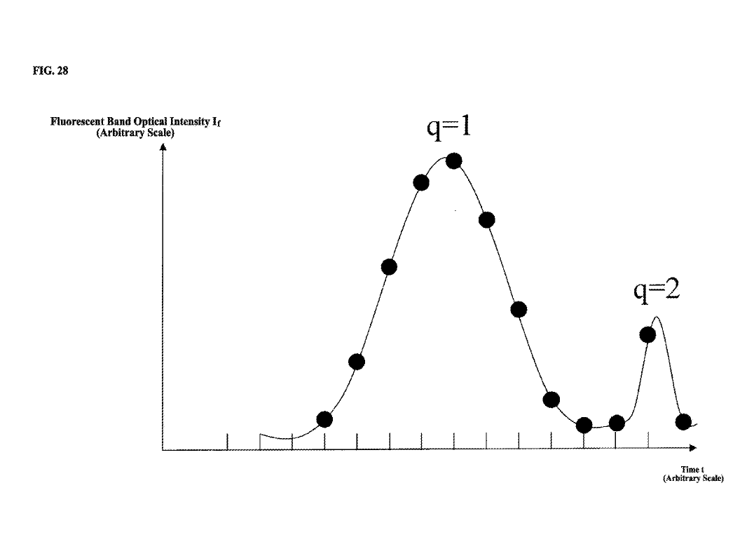

Step S501 through Step S507 of FIG. 27 are executed identically to Step S401 through Step S407 in FIG. 25. However, in Step S507, the optical intensity calculating device 23A stores, to the optical intensity storing device 24A that is included in the fluorescent intensity measuring instrument 2, the integral value of the intensity of light in the fluorescent band at the first peak, shown in FIG. 28.

In Step S508, the fluorescent intensity measuring device 2 evaluates whether or not the rate of change over time ΔI_{f}/Δt of the intensity of light in the fluorescent band is near to zero. If the rate of change over time ΔI_{f}/Δt of the intensity of light in the fluorescent band has not gone to near zero, then, as illustrated in FIG. 28, the evaluation is that a second peak has appeared, and processing returns to Step S502, where Step S503 through Step S506 are executed, and, in Step S507, the optical intensity calculating device 23A stores, in the optical intensity storing device 24A that is included in the fluorescent intensity measuring instrument 2, the integral value of the intensity of light in the fluorescent band at the second peak. After the loop from Step S502 through Step S508 is iterated, then if, in Step S508, the rate of change over time Δ_{f}/Δt of the intensity of light in the fluorescent band can has reached approximately zero, then the optical intensity calculating device 23A, in Step S509, evaluates that the passage of the plurality of particles or the substance from the position of illumination of the excitation beam has been completed.

In Step S510, the optical intensity calculating device 23A, after, for example, measurement of a first peak, specifies, as an offset C1, an intensity of light in the fluorescent band at the first wavelength, detected by the first photodetecting element 20A, and after, for example, measurement of a second peak, specifies, as an offset C2, an intensity of light in the fluorescent band at the second wavelength, detected by the second photodetecting element 20B. Moreover, the optical intensity calculating device 23A calculates a value that is the offset C1 times the number of data points N₁ when integrating the first peak, and calculates a value that is the offset C2 times the number of data points N₂ when integrating the second peak.

In Step S511, the optical intensity calculating device 23A subtracts a value that is the offset C1 multiplied by N₁ from the integral value of the intensity of light in the fluorescent band at the first peak, saved in the optical intensity storing device 24A, to calculate the corrected integral value of the light in the fluorescent band at the first peak, and stores this in the optical intensity storing device 24A as the intensity of light in the fluorescent band at the first wavelength. Moreover, the optical intensity calculating device 23A subtracts a value that is the offset C2 multiplied by N₂ from the integral value of the intensity of light in the fluorescent band at the second peak, saved in the optical intensity storing device 24A, to calculate the corrected integral value of the light in the fluorescent band at the second peak, and stores this in the optical intensity storing device 24A as the intensity of light in the fluorescent band at the second wavelength.

The method described above enables easy calculation of the relative value for a substance wherein the intensity of light is weak, using the integral value of the intensity of the light. This enables the intensity of light at the respective peaks of a plurality of substances to be measured. Note that the method by which the fluorescent intensity measuring instrument 2 calculates, and saves in the optical intensity storing device 24B, the intensity of light in the fluorescent band at the second wavelength, using the second photodetecting element 20B, is identical to the method described above, so the explanation thereof will be omitted.

### Other Examples

While there are descriptions of examples as set forth above, the descriptions and drawings that form a portion of the disclosure are not to be understood to limit the present disclosure. A variety of alternate examples and operating technologies should be obvious to those skilled in the art. For example, the location wherein the particle detecting device 1 according to the present example is not limited to being a clean room. Furthermore, while, in the present example, a method was shown wherein the relative value was calculated by measuring the optical intensity at a first wavelength and measuring the optical intensity at a second wavelength, the optical intensities may be measured at three or more wavelengths, and the relative value may be calculated therefrom.

Furthermore, the breakdown degree storing device 355 may store a function wherein the operating time of the light source 10 or of the fluorescent intensity measuring instrument 2 is the independent variable and the breakdown coefficient is the dependent variable, or a function wherein the ambient temperature of the fluorescent intensity measuring instrument 2 is the independent variable and the breakdown coefficient is the dependent variable. Furthermore, the reference value storing device 351 may store reference values for substances that are included in the air, such as for nitrogen oxides (NO_{X}) including nitrogen dioxide (NO₂), sulfur oxides (SO_{X}), ozone gas (O₃), aluminum oxide gases, aluminum alloys, glass powders, decontaminating gases for decontaminating contamination such as Escherichia coli and mold, for example, and the like. The reference values for prescribed substances that are included in the air may be obtained through, for example, in Step S201 of FIG. 6, filtering the air and then eliminating from the air particles of the degree that produce Mie scattering, to produce air wherein nitrogen dioxide (NO₂), and the like, remains. In this way, the present disclosure should be understood to include a variety of examples, and the like, not set forth herein.

1. A particle detecting device comprising:
a light source that illuminates a fluid with an excitation beam;
a fluorescent intensity measuring instrument that measures an optical intensity of a fluorescent band, generated in a region that is illuminated by the excitation beam, at two or more wavelengths;
a boundary range storing device that stores, as a boundary range, a range of optical intensities at two or more wavelengths for discriminating between a fluorescent particle that is a subject to be detected and a particle that is not a subject to be detected;
an evaluating portion that compares a measured value for the optical intensity and the boundary range to evaluate whether or not a fluid includes a fluorescent particle that is a subject to be detected, and evaluates that, when the measured value for the optical intensity is included in the boundary range, an evaluation whether or not the fluid includes a fluorescent particle that is a subject to be detected is not possible; and
a correcting portion that corrects the boundary range in accordance with the status of at least one of the light source and the fluorescent intensity measuring instrument.

2. The particle detecting device as set forth in claim 1, wherein
the fluorescent intensity measuring instrument comprises two or more photodetecting elements corresponding to the two or more wavelengths, and
the correcting portion corrects the measured value or the reference value for the optical intensity in accordance with the number of times that the two or more photodetecting elements have each detected the light in the fluorescent band.

3. The particle detecting device as set forth in claim 2, wherein
the correcting portion corrects the measured value or the reference value for the optical intensity in accordance with the number of times that the two or more photodetecting elements have each detected the light of greater than a specific intensity in the fluorescent band.

4. The particle detecting device as set forth in claim 1, wherein
the fluorescent intensity measuring instrument comprises two or more photodetecting elements corresponding to the two or more wavelengths, wherein
the correcting portion corrects the measured value or the reference value for the optical intensity in accordance with the integral intensity of the light detected by the two or more photodetecting elements in the fluorescent band.

5. The particle detecting device as set forth in claim 4, wherein
the correcting portion corrects the measured value or the reference value for the optical intensity in accordance with the integral intensity of the light detected by the two or more photodetecting elements in the fluorescent band of greater than a prescribed intensity.

6. The particle detecting device as set forth in claim 1, further comprising:
a relative value calculating portion that calculates, as a measured relative value, a relative value for the intensities of light measured at the two or more wavelengths, wherein
the evaluating portion compares a measured relative value for the optical intensity and the boundary range to evaluate whether or not a fluid includes a fluorescent particle that is a subject to be detected, and evaluates that, when the measured relative value is included in the boundary range, an evaluation whether or not the fluid includes a fluorescent particle that is a subject to be detected is not possible.

7. A particle detecting method, comprising:
Illuminating a fluid by a light source with an excitation beam;
measuring by a fluorescent intensity measuring instrument, at two or more wavelengths, an optical intensity of fluorescent bands that are produced in a region that is illuminated by the excitation beam;
preparing, as a boundary range, a range of optical intensities at the two or more wavelengths in order to discriminate between a fluorescent particle that is a subject to be detected and a particle that is not a subject to be detected;
comparing at an evaluating portion a measured value for the optical intensity and the boundary range to evaluate whether or not a fluid includes a fluorescent particle that is a subject to be detected, and evaluating at the evaluating portion that, when the measured value for the optical intensity is included in the boundary range, an evaluation whether or not the fluid includes a fluorescent particle that is a subject to be detected is not possible; and
correcting the boundary range in accordance with the status of the fluorescent intensity measuring instrument measuring the optical intensity of the fluorescent bands at the two or more wavelengths.

8. The particle detecting method as set forth in claim 7, wherein
the fluorescent intensity is measured by two or more photodetecting elements corresponding to the two or more wavelengths, and
the measured value or the reference value for the optical intensity is corrected in accordance with the number of times that the two or more photodetecting elements have each detected the light in the fluorescent band.

9. The particle detecting method as set forth in claim 8, wherein
the measured value or the reference value for the optical intensity is corrected in accordance with the number of times that the two or more photodetecting elements have each detected the light of greater than a specific intensity in the fluorescent band.

10. The particle detecting method as set forth in claim 7, wherein
the fluorescent intensity is measured by two or more photodetecting elements of the fluorescent intensity measuring instrument, corresponding to the two or more wavelengths, and
the measured value or the reference value for the optical intensity is corrected in accordance with the integral intensity of the light detected by the two or more photodetecting elements in the fluorescent band.

11. The particle detecting method as set forth in claim 10, wherein
the measured value or the reference value for the optical intensity is corrected in accordance with the integral intensity of the light detected by the two or more photodetecting elements in the fluorescent band of greater than a prescribed intensity.

12. The particle detecting method as set forth in claim 7, wherein
a relative value for the intensities of light measured is calculated by a relative value calculating portion, as a measured relative value, at the two or more wavelengths,
a measured relative value for the optical intensity is compared to the boundary range to evaluate whether or not a fluid includes a fluorescent particle that is a subject to be detected, and,
when the measured relative value is included in the boundary range, an evaluation whether or not the fluid includes a fluorescent particle that is a subject to be detected is determined as not possible.
